(19) United States
(12) Patent Application Publication
(10) Pub. No.: US 2026/0313082 A1
(43) Pub. Date: Oct. 8, 2026

(54) HEAD-MOUNTED DISPLAY ADJUSTMENT METHODS AND SYSTEMS

(71) Applicant: DOLBY LABORATORIES LICENSING CORPORATION

(72) Inventors: Dae Yeol LEE, San Jose, CA (US); Guan-Ming SU, Fremont, CA (US)

(73) Assignee: DOLBY LABORATORIES LICENSING CORPORATION, (US)

(21) Appl. No.: 19/489,846

(22) PCT Filed: Jun. 5, 2024
(86) PCT No.: PCT/US2024/032625

§ 371 Date: Dec. 3, 2025

Related U.S. Application Data
(60) Provisional application No. 63/507,726, filed on Jun. 12, 2023.

(30) Foreign Application Priority Data
Jul. 12, 2023 (EP) 23184926.6

(51) Int. Cl. H04N 13/128; H04N 13/178; H04N 13/194; H04N 13/332; H04N 13/398

(52) U.S. Cl. CPC H04N 13/128; H04N 13/178; H04N 13/194; H04N 13/332; H04N 13/398

(57) ABSTRACT

Methods and systems are described for processing a stereo video stream with one or more post-processing factor that can adjust the sense of depth for a user of the stereo video stream in a head mounted display. In one embodiment, a decoder receives a stream that include the stereo video stream and disparity statistics for the stream. The decoder demultiplexes the stream to recover the stereo video stream and the disparity statistics. Using the disparity statistics, the decoder computes a post-processing factor that can be one or more of a scale and a shift factor. The decoder applies the post-processing factor to the decoder stereo stream, where the resulting stereo video stream is provides the desired level of sense of depth for the user of the head mounted display.

### CROSS-REFERENCE TO RELATED APPLICATIONS

This application claims the benefit of priority from U.S. Provisional Patent Application Ser. No. 63/507,726, filed on Jun. 12, 2023 and European Patent Application No. 23184926.6, filed on Jul. 12, 2023.

### TECHNOLOGY

The present invention relates generally to viewing video. More particularly, an embodiment of the present invention relates to using disparity metadata to aid in the stereo viewing comfort adjustment on head-mounted displays.

### BACKGROUND

Stereo media contents provide a sense of depth through introducing stereo disparities which are differences in object locations in left and right view. Studies have shown that there are certain ranges of depth that are perceived comfortably, denoted as zone of comfort, which are affected by various viewing conditions such as screen distance or interpupillary distance (IPD).

Recent increased interests in augmented reality (AR) and virtual reality (VR) technologies have enabled the growth of head-mounted display (HMD) industries. Manufacturers are introducing price-competitive and high-quality HMDs to the consumer market and providing new ways to enjoy stereo medias. However, as these HMDs have different viewing conditions compared to the traditional stereoscopic cinemas or televisions, existing stereo content that is rendered for these displays may need adjustments on depth to prevent any visual discomforts. It should be also noted that recent HMDs provide functions to adjust the lens spacing to match the user's IPD, which makes the issue more challenging, as the viewing condition may alter depending on the decision at the device side.

### BRIEF DESCRIPTION OF THE DRAWINGS

The present invention is illustrated by way of example and not limitation in the figures of the accompanying drawings in which like references indicate similar elements.

FIG. 1 shows an example of a system that can be used in one or more embodiments the invention.

FIG. 2 shows an example of an optical setting of a head-mounted display that can be used with one or more embodiments of the invention.

FIG. 3 shows, in a flow diagram, an example of a decoder that can be used with one or more embodiments of the invention.

FIG. 4 shows, in a flow diagram, an example of an encoder that can be used with one or more embodiments of the invention.

FIG. 5 shows an example of disparity statistics that can be used with one or more embodiments of the invention.

FIG. 6 shows, in a flow diagram, an example of a HYBRID disparity extraction method that can be used with one or more embodiments of the invention.

FIG. 7 shows an example of comfort zone disparities on different viewing conditions that can be used with one or more embodiments of the invention.

FIG. 8 shows, in a flow diagram, an example of a scale/shift parameter decisions that can be used with one or more embodiments of the invention.

FIG. 9 shows an example of an effect of scale on the disparity statistics that can be used with one or more embodiments of the invention.

FIG. 10 shows an example of an effect of shift on the disparity statistics that can be used with one or more embodiments of the invention.

FIG. 11 shows an example of a visualization of original and applied horizontal coordinate that can be used with one or more embodiments of the invention.

FIG. 12 shows an example of original and transformed horizontal coordinates that can be used with one or more embodiments of the invention.

FIG. 13 shows an example of an effect of IPD on FOV and screen region that can be used with one or more embodiments of the invention.

FIGS. 14A-C shows examples of a set of scale and shift factors applied to a video frame that can be used with one or more embodiments of the invention.

FIG. 15 shows an example of a plot of black border that can be used with one or more embodiments of the invention.

FIG. 16 shows an example of a comparison of optimal scale factor, optimal shift factor, and black border area that can be used with one or more embodiments of the invention.

FIG. 17 shows an example of an effect of shift and/or scale for comfort and adventure modes that can be used with one or more embodiments of the invention.

FIG. 18 shows, in a flow diagram, an example of a scale/shift application that can be used with one or more embodiments of the invention.

FIG. 19 shows an example of a data processing system that can be used to perform or implement one or more embodiments of the invention.

### DETAILED DESCRIPTION

Various embodiments and aspects will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments.

Reference in the specification to “one embodiment” or “an embodiment” means that a particular feature, structure, or characteristic described in conjunction with the embodiment can be included in at least one embodiment. The appearances of the phrase “in one embodiment” in various places in the specification do not necessarily all refer to the same embodiment. The processes depicted in the figures that follow are performed by processing logic that comprises hardware (e.g., circuitry, dedicated logic, etc.), software, or a combination of both. Although the processes are described below in terms of some sequential operations, it should be appreciated that some of the operations described may be performed in a different order. Moreover, some operations may be performed in parallel rather than sequentially.

The embodiments described herein can be used to process a stereo video stream to be more comfortable for a user using disparity statistics of that video stream. In one embodiment, a method is described that can provide a comfortable stereo viewing experience in head-mounted displays (HMD). Stereo media contents provide sense of depth through introducing stereo disparities which are differences in object locations in left and right view. Studies have shown that there are certain ranges of depth that are perceived comfortably, denoted as zone of comfort, which are affected by various viewing conditions such as screen distance or interpupillary distance (IPD).

Recent increased interests in augmented reality (AR) and virtual reality (VR) technologies have enabled the growth of HMD industries. Manufacturers are introducing price-competitive and high-quality HMDs to the consumer market, providing new ways to enjoy stereo medias. However, as these HMDs have different viewing conditions compared to the traditional stereoscopic cinemas or televisions, existing stereo contents that are rendered for these displays may need adjustments on depth to prevent any visual discomforts. It should be also noted that recent HMDs provide functions to adjust the lens spacing to match the user's IPD, which makes the issue more challenging, as the viewing condition may alter depending on the decision at the device side.

One possible approach is to render multiple novel stereo views for possible candidates of viewing conditions and use multi-view AVC or HEVC codec to encode those multiple views. The decoder side will be choosing which view to take depending on the viewing condition. However, such method incurs a high overhead which is not suitable for networks with limited bandwidth. Another disadvantage is the storage size at the server side that is needed to store multiple bitstreams using different viewing conditions. This problem will get even worse when the bit rate ladder (for adaptive streaming) is applied to handle varying network conditions.

A more efficient way is to receive the stereo content as is, then control the disparities from the decoder (device) side according to its derived zone of comfort. As the left/right view rendering is now done on the decoder side, scaling and shifting of the stereo content can be performed, which are relatively light-weight computations.

A method according to one embodiment can include the following operations: computing, with a decoding device, a comfort threshold using a parameter input by a user, receiving a stereo video stream and metadata corresponding to the stereo video stream, wherein the metadata includes an indication of disparities between a corresponding left and right frame of the stereo video stream; computing a post-processing factor for the stereo video stream using the metadata and comfort threshold; and processing the stereo video stream using the post-processing factor.

In one embodiment, the inputted parameter can include one or more of interpupillary distance (IPD) screen distance, screen size, and pixels/screen. In one embodiment, the method can be adapted to compute the comfort threshold computing the comfort threshold using the IPD, screen distance, screen size, and pixels/screen. In one embodiment, the post-processing factor is one or more of a scale factor and a shift factor. In one embodiment, the method can be adapted to process the stereo video stream by scaling the stereo video stream using the scaling factor. In one embodiment, the method can be adapted to process the stereo vide stream by shifting each pair of frames in the stereo video stream using the shifting factor, wherein a shifting includes shifting a left side frame towards a corresponding right side frame or shifting the left side frame away from the corresponding right side frame.

In one embodiment, the method can be adapted to process the stereo video stream by retrieving disparity statistics from the metadata, wherein the disparity statistics include the indications of disparities between corresponding left and right frames of the stereo video stream, retrieving comfort threshold, and computing the post-processing factor using the disparity statistics and comfort threshold. In one embodiment, the disparity statistics are the range of disparities that a frame or a group of frames within a scene covers. In one embodiment, the disparity statistics are computed by an encoding device that encoded the stereo video stream. In one embodiment, the disparity statistics includes (dₘᵢₙ, dₘₐₓ) values for each frame or for a group of frames that constitute a scene. In one embodiment, the input mode is one of a comfort mode and an adventure mode. In this embodiment, the comfort mode is used to reduce the disparity of the content. It can be used when the stereo video stream includes a disparity that is outside the comfort zone range but is not limited to the scenario and can still be operated even when disparities are within the comfort zone by user specification. Furthermore, the adventure mode is used to increase the disparity of the content. It can be used when the stereo video stream includes disparities are within the comfort zone range to explore greater sense of depth but is not limited to the scenario and can still be operated even when disparities are already outside the comfort zone if specified by the user. In one embodiment, the computing of the post-processing factor uses at least one of an input mode and a threshold control.

The embodiments described herein can be used in apparatuses which include one or more processors in a processing system and which include memory and which are configured to perform any one of the methods described herein. Moreover, the embodiments described herein can be implemented using non-transitory machine-readable storage media storing executable computer program instructions which when executed by a machine cause the machine to perform any one of the methods described herein.

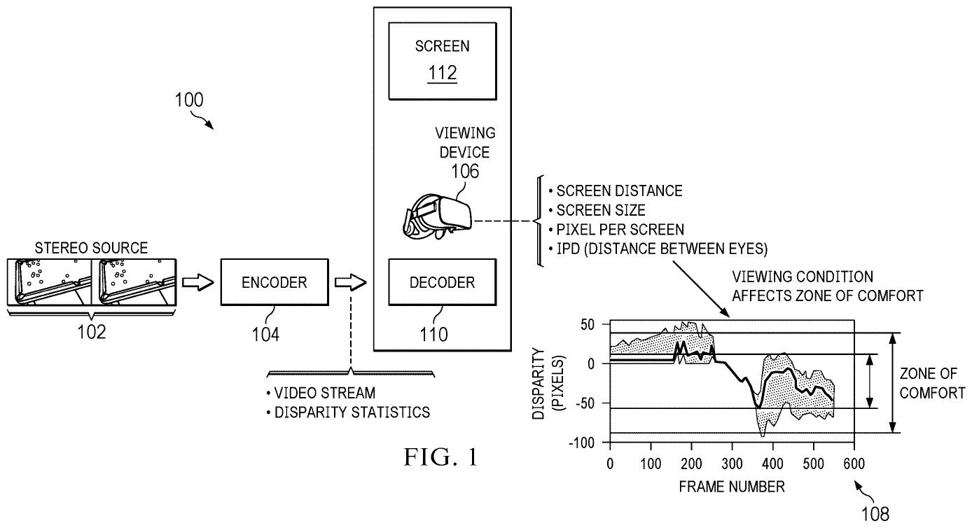

FIG. 1 shows an example of a system 100 that can be used in one or more embodiments the invention. In FIG. 1, the system 100 includes a stereo source 102 that is fed to an encoder 104. In one embodiment, the encoder 104 is a device that can encode the stereo source 102 by converting an analog or digital video to another digital video format that can be used to deliver to the encoded video to a decoder 110. In this embodiment, the encoder 104 can be a server, personal computer, laptop, camera, smartphone, or another device that can encode a stereo source 102. In one embodiment, the stereo source 102 is a video source that can produce a three-dimensional image in a moving form.

In a further embodiment, the encoder 104 sends the digitized stereo video to a decoder 110. In one embodiment, the decoder 110 decodes the encoded stereo video output by the encoder 104 that can be used to output to a viewing device. In this embodiment, the decoder 110 can be a server, personal computer, laptop, camera, smartphone, or another device that can decode the encoder stereo video. In one embodiment, the decoder 110 is part of a viewing device 106 that includes a screen for outputting the decoded stereo video. In one embodiment, the viewing device 106 is a head mounted display (HMD), where an HMD is a display device worn on the head with a display in front of one or both eyes of a user. In this embodiment, the viewing device 106 includes metadata for screen size, screen distance, pixels per screen, IPD, and or other metadata regarding the HMD. Furthermore, this metadata can be used by the viewing device to determine a zone of comfort for the user of the HMD. In one embodiment, the viewing device 106 can apply a post-processing factor to the decoded video so that the resulting stereo video is more comfortable or more exciting with increased sense of depth to the HMD users.

It is believed that the viewing discomfort in stereo video experience comes from the vergence and accommodation conflict (VAC). Vergence is the rotation of the eyes toward or away from one another. The eyes' lines of sight rotate toward one another—e.g., converge—when shifting gaze from a far to a near object, and rotate away from one another—diverge—when shifting from near to far. Vergence is quantified by the vergence distance which is the distance from the eyes to the intersection of the lines of sight. Accommodation is the adjustment of the eye's optics to bring an object into focus on the retina. It is achieved by adjusting the focal length of the eye's crystalline lens. When shifting gaze from a near to a far object, focal length is increased. When shifting from far to near, focal length is decreased. Accommodation is quantified by the accommodative distance which is the distance from the eye to the focal plane. The accommodation distance is also called focal distance, screen distance, or viewing distance. A natural viewing occurs when the accommodation distance is equal or nearly equal to the vergence.

In one embodiment, there is a zone of comfort for viewing the stereo video in a head mounted display. This zone of viewing comfort is the set of vergence and accommodation distances that does not produce blurred or doubled vision. A general procedure of measuring the zone of viewing comfort is to change the vergence distance with a prism while keeping the accommodative distance (i.e., screen distance) constant. In this way, one can find the largest convergence and largest divergence for which the viewer can maintain a single, well-focused image.

According to the prior work, there are some tolerance regions that provide viewing comfort. Many have conducted studies for deriving these regions of comfort. Among them Percival's and Sheard's zone of comfort was mainly investigated based on optical correction scenario. The optical correction and stereo viewing scenarios have considerable differences between the two zones of comfort. These differences are: (1) The optical correction poses a conflict that is constant in diopters, but stereo viewing poses a conflict that varies in magnitude and directions depending on different depths within the scene; and (2) The stereo viewing occurs for a shorter duration compared to the optical correction. Due to these differences, it was hard to generalize the results from Percival's and Sheard's to the stereo viewing scenario. In one embodiment, a new zone of comfort was derived that is relevant to the stereo viewing scenarios. The fit parameters of these zone of comfort curves contain tendencies from perceptual experiments and will be utilized throughout this document for deriving various comfort zone thresholds.

In one embodiment, let Dᵥ denote a vergence distance in diopters. In addition, let D_{f,far} and D_{f,near} denote the accommodation distance for upper and lower curves in diopters, respectively. Note that D_{f,far} here refers to the boundary corresponding to negative conflict which happens on the stereo content behind the screen. D_{f,near} refers to the boundary corresponding to positive conflict which happens on the stereo content in front of the screen. Let m_{far} and mₙₑₐᵣ denote the slopes of the upper and lower curves, respectively, and T_{far} and Tₙₑₐᵣ denote the ordinate intercepts for the upper and lower curves, respectively. This can be expressed the zone with the following equations

$${D}_{f , far} = {m}_{far} {D}_{v} + {T}_{far} \qquad ( 1 )$$

$${D}_{f , near} = {m}_{near} {D}_{v} + {T}_{near} \qquad ( 2 )$$

where fit parameters are m_{far}=1.129, T_{far}=0.442, mₙₑₐᵣ=1.035, Tₙₑₐᵣ=−0.626. These perceptual fit parameters can be used to derive curves in different units also. For instance, there may be cases where curve bases on meters is more desirable than those in Diopters. In such case let us denote the accommodation distances in meters as d_{f,far} and d_{f,near}. The vergence distance in meters is denoted as dᵥ. Since diopter is reciprocal of meters,

$${D}_{f , far} = \frac{1}{{d}_{f , far}} ,$$

$${D}_{f , near} = \frac{1}{{d}_{f , near}} , and {D}_{v} = \frac{1}{{d}_{v}} .$$

Then, the equation (1) and (2) can be expressed as,

$$\frac{1}{{d}_{f , far}} = {m}_{far} \frac{1}{{d}_{ν}} + {T}_{far} \qquad ( 3 )$$

$$\frac{1}{{d}_{f , near}} = {m}_{near} \frac{1}{{d}_{v}} + {T}_{near} \qquad ( 4 )$$

where d_{f} and dᵥ are viewing and vergence distance in meters, respectively. Eqs. (3) and (4) can be further expanded as,

$${d}_{f , far} = \frac{{d}_{v}}{{m}_{far} + {T}_{far} {d}_{v}} \qquad ( 5 )$$

$${d}_{f , near} = \frac{{d}_{v}}{{m}_{near} + {T}_{near} {d}_{v}} \qquad ( 6 )$$

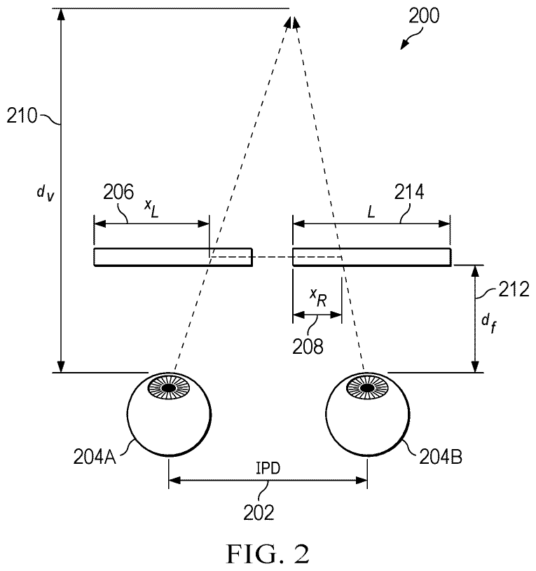

A person's IPD is on average 63 mm with standard deviation of 3.8 mm. In accordance with the possible variation of IPDs among users, recent HMDs support adjusting lens distances in accordance with the user's IPD. For instance, an HMD supports adjusting lens spacing to three different levels of 58, 63, and 68 mm. In one embodiment, instead of supporting simple IPD levels, the IPD can be formulated for the zone of comfort equations to also consider the effect of IPDs. Also, considering that the vergence distances are determined by disparities in the stereo viewing scenarios, the vergence distance is expressed as disparities. FIG. 2 shows an example of an optical setting 200 of an HMD that can be used with one or more embodiments of the invention. In FIG. 2, the L (214) refers to the virtual screen size. The dᵥ (210) and d_{f} (212) each refer to the vergence distance and the distance to the virtual screen, respectively. The x_{L} (206) and XR (204) each refer to the coordinate of the matching objects on the left and right view, respectively. In addition, the IPD (202) is illustrated between eyes 204A-B.

According to the similar triangle property,

$$\frac{{d}_{v}}{IPD} = \frac{{d}_{v} - {d}_{f}}{IPD - ( \frac{L}{2} - {x}_{R} ) - ( {x}_{L} - \frac{L}{2} )} = \frac{{d}_{v} - {d}_{f}}{IPD - s} \qquad ( 7 )$$

where s refers to disparity defined as

$$s = {x}_{L} - {x}_{R} \qquad ( 8 )$$

Expanding (7) gives

$${d}_{v} = \frac{{d}_{f} IPD}{s} . \qquad ( 9 )$$

Combining (9) with (3) and (4), results in

$${s}_{far} = {g}_{far} ( {d}_{f} , IPD ) = \frac{- IPD}{{m}_{far}} ( {T}_{far} {d}_{f} - 1 + {m}_{far} ) \qquad ( 10 )$$

$${s}_{near} = {g}_{near} ( {d}_{f} , IPD ) = \frac{- IPD}{{m}_{near}} ( {T}_{near} {d}_{f} - 1 + {m}_{near} ) \qquad ( 11 )$$

Any disparities that lie within the range s_{far}~sₙₑₐᵣ are considered to provide viewing comfort. From (10) and (11), this range is dependent on IPD and d_{f}. In one embodiment, the zone of comfort on varying (d_{f}, IPD) can be expressed using two threshold curves, where a curve can indicate a positive conflict threshold sₙₑₐᵣ which happens at positive disparities. Conversely, another curve can indicate a negative conflict threshold s_{far} which happens at negative disparities. The zone of comfort covers more range of disparities as d_{f} and/or IPD increases. This means that stereo contents are subject to higher chance of discomfort if distance to screen and/or IPD is lower. In one embodiment, the zone of viewing comfort is dependent on viewing condition parameters such as IPD that are subject to change on the device side. This emphasizes the need of a flexible framework that can adapt to these changing viewing conditions and control the content's disparities from the decoder side to provide comfortable viewing experience.

As illustrated above, because a user's IPD can vary from user to user, a flexible framework can be used to determine a more applicable zone of comfort for the user. In one embodiment, a decoder can receive an encoded stereo video and apply a post-processing factor to shift and/or scale the stereo video that produces a stereo video that is within a zone of comfort for the user.

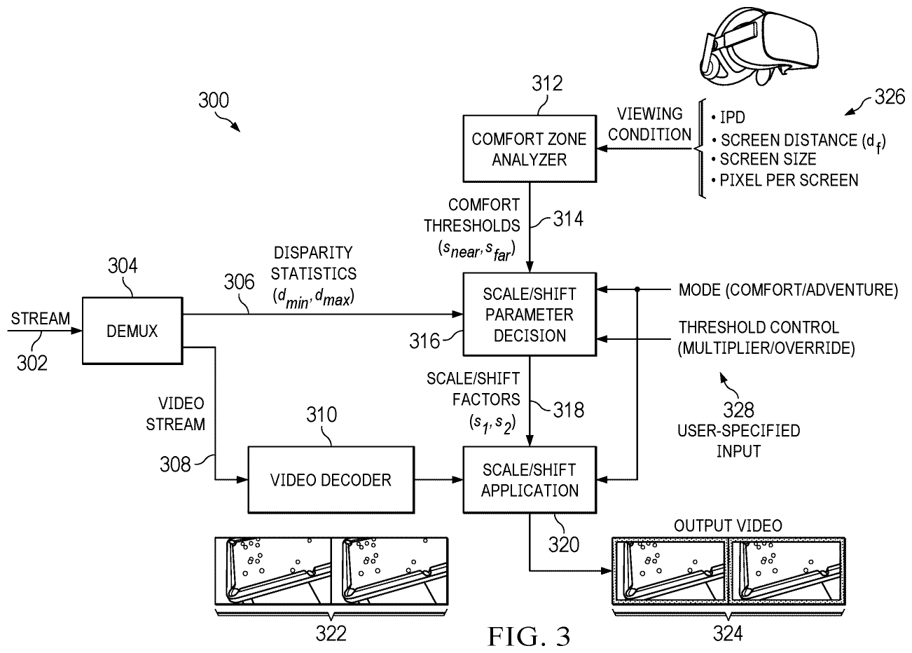

FIG. 3 shows, in a flow diagram, an example of a decoder 300 that can be used with one or more embodiments of the invention. In FIG. 3, the decoder 300 receives a stream 302, where the stream includes a video stream of the stereoscopic video and disparity statistics information of that video stream. In addition, the decoder 300 receives viewing condition parameters 326 that are acquired from the display device that can include one or more of the IPD, screen distance, screen size, and pixel per screen. In another embodiment, additional viewing parameters can be received. The parameters are used to estimate the thresholds for the comfort zone on current viewing condition.

Further, in one embodiment, the decoder 300 can receive user specified inputs 328 from a video player (not illustrated) on the decoder side. In one embodiment, these inputs can be used to fine-control the viewing experiences according to the user's need. In this embodiment, one of the inputs is the ‘Mode’ specification. Two (or more) different operating modes can be provided such as a comfort mode and an adventure mode. The comfort mode can be used for contents with disparities that deviate out of comfort zone ranges where the mode can control the disparities to reside within the comfort zone ranges. However, the use of the comfort mode is not limited to such scenario and user can still configure to use even when disparities are within the comfort zone to further decrease the disparities. The adventure mode can be used for contents with disparities that are already inside the comfort zone that can bring the disparity statistics closer to either of the positive or negative disparity threshold to provide increase sense of depth while not introducing discomfort. As described above, the use of the adventure mode is not limited to such scenario, and user can specify greater disparities even if the content disparity is already outside the comfort zone. Another kind of user specified input is ‘Threshold control’. The user can either specify a multiplier to apply on the computed comfort zone thresholds or override the values by specific values.

With the various inputs, the decoder 300 can process the stream 302. In one embodiment, the decoder 300 demultiplexes (304) the video stream 308 and the disparity statistics 306 from the stream 302. In one embodiment, the video stream 308 is sent to the video decoder 310 and the disparity statistics 306 is sent to the scale/shift parameter decision process 316. In a further embodiment, the decoder 300 receives the viewing condition parameters and determines comfort thresholds 314 (sₙₑₐᵣ, s_{far}) using a comfort zone analyzer 312. In one embodiment, the comfort zone analyzer 312 receives the viewing condition parameters 326 which include IPD, screen distance, screen size, and pixels per screen. Based on these parameters, the module outputs comfort thresholds s_{far} and sₙₑₐᵣ where s_{far}~sₙₑₐᵣ indicates a range of disparities, in the unit of pixels, that fall into the zone of comfort at current viewing conditions. The decoder 300 feeds the comfort thresholds 314 to the scale/shift parameter decision process 316.

In one embodiment, the scale/shift parameter decision process 316 receives the comfort thresholds (s_{far}, sₙₑₐᵣ) 314 from the comfort zone analyzer 312 and per-frame disparity statistics (dₘᵢₙ, dₘₐₓ) 306 from the input stream 302. The scale/shift parameter decision process 316 also receives user specified inputs 328 which are mode information and threshold control. Using these inputs, the scale/shift parameter decision process 316 determines the scale/shift factors (s₁, s₂) 318 to apply on the given stereo view to drive the disparities into desired direction. With the scale/shift factors (s₁, s₂) 318, the decoder 300 uses the scale/shift application 320 to apply a scale and/or shift factor to the to the decoded video stream. In one embodiment, the scale/shift application 320 receives the decoded video from the input stream, scale/shift factors (s₁, s₂) 318 from the scale/shift parameters decision process 316, and user specified mode information 328. From these inputs, the scale/shift application 320 applies the appropriate scale/shift on the stereo views that can be displayed as the resulting output video. In one embodiment, s₁ is the scale factor and s₂ is the shift factor. In one embodiment, because the scale and shift factors are computed on disparity statistics that change over the length of the stereo video stream, the scale and shift factors can independently change over the length of the stereo video stream, with different scale and/or shift factors being applied to different frames or groups of frames of different views of the stereo video stream. In a further embodiment, the mode (e.g., comfort or adventure) can be changed by a user during the playback of the stereo video stream.

As described above, the decoder uses disparity statistics of the stereo video stream that, in one embodiment, are generated by an encoder. In one embodiment, the encoder generates a decoder-compatible stream where the stereo video stream is multiplexed with disparity statistics information. Here, the disparity statistics refer to (dₘᵢₙ, dₘₐₓ) values sent for each frame. The dₘᵢₙ~dₘₐₓ specifies the range of disparities that the corresponding frame covers. The disparity statistics may be generated using different algorithms from the encoder side depending on the desired level of accuracy and computational complexity.

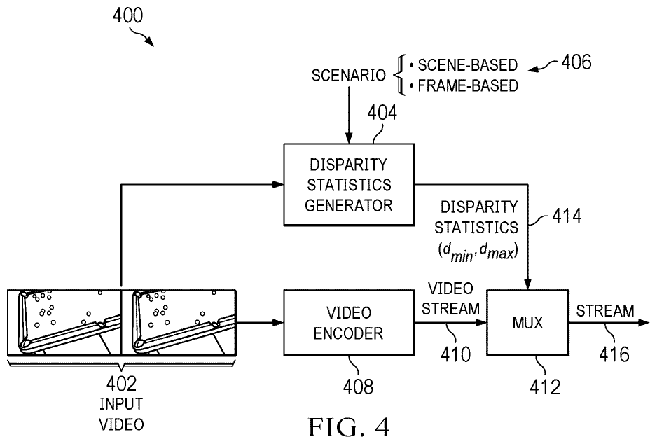

FIG. 4 shows, in a flow diagram, an example of an encoder 400 that can be used with one or more embodiments of the invention. In FIG. 4, the encoder 400 includes a disparity statistics generator 404 to generate the disparity statistics 414 and a video encoder 408 to encode the input video 402 to a video stream 410. In addition, the encoder 400 includes a multiplexer 412 that multiplexes the encoded video stream 410 with the disparity statistics 414 to output the resulting stream 416 that is used by the decoder above.

In one embodiment, the disparity statistics generator 404 can generate the disparity statistics using one of two different ways. A scene-based disparity statistics generator considers the disparity statistics holistically on a scene basis. More specifically, the disparities are collected for the whole scene, then the (dₘᵢₙ, dₘₐₓ) are extracted from them and assigned identically to all frames constituting the scene. As the disparity statistics of the frames from same scene are sent identically, the disparity control (scale/shift) operations on the decoder side are also consistent per scene. Unless specified otherwise, this scenario is considered as the default scenario, as it is expected to provide more consistent viewing experiences.

In another embodiment, a frame-based disparity statistics generator considers the per-frame disparity statistics. In this case, even if the frames are from the same scene, the disparity statistics may change on each frame. On decoder side, this may cause different (scale/shift) operations to be applied on the frames from the same scene. In one embodiment, a moving average window can be applied from the encoder side on disparity statistics or from the decoder side on the determined scale/shift factors for more consistent viewing experiences. This frame-based mode may be considered in scenarios such as live streaming where the scene-cut information is not readily available.

In one embodiment, the disparity statistics are generated by the encoder and transmitted along with the video stream to the decoder. By having the encoder compute the disparity statistics, the computation burdens on the decoder are lessened. This, thus, improves the functioning of the decoder by generating the disparity statistics when encoded instead of when the video stream is decoded. As discussed above, the disparity statistics generator generates (dₘᵢₙ, dₘₐₓ) per frame on two possible scenarios of ‘scene-based’ and ‘frame-based’. While in one embodiment, the disparity statistics generator can use a scene-based or frame-based disparity statistics generator, in alternative embodiment, other algorithms may be used for disparity statistics generation based on the desired accuracy and complexity.

In one embodiment, the disparity statistics generator specifies the range of disparities dₘᵢₙ~ dₘₐₓ of a corresponding frame for each frame in the video stream. In this embodiment, let d(k)={s_{(k,1)}, . . . , s_{(k,N}_{ₖ}₎} denote an array of disparities collected at k-th frame where s_{(k,l)} refers to the individual disparity (the l-th one) in the k-th frame. The k∈[1, F], where F refers to the number of frames of the video. The l∈[1, N_{K}], where Nₖ refers to the number of matching points between the left and right views of the k-th frame. Note that Nₖ may vary on different ks depending on the disparity extraction algorithm. For instance, disparity computation based on feature matching may extract different number of matching points per each frame depending on the frame content.

The disparity statistics for the frame-based scenario can be derived simply as:

$${d}_{min} ( k ) = {P}_{10} ( d ( k ) ) \qquad ( 12 )$$

$${d}_{max} ( k ) = {P}_{90} ( d ( k ) ) \qquad ( 13 )$$

where P₁₀ and P₉₀ refer to functions that output 10^{th} and 90^{th} percentile element, respectively. The percentile values were chosen to cover most disparities excluding the extreme 10 percentiles in both directions, and, of course, other percentile ranges may be used.

The scene-based scenario considers the disparities of a scene holistically and determines universal dₘᵢₙ and dₘₐₓ values to assign to the frames within the same scene. Regarding dₘᵢₙ, this is done by collecting frame-based dₘᵢₙ computed by (12) for frames within the scene, then choosing the minimum element among them. Regarding dₘₐₓ, this is done by collecting frame-based dₘₐₓ computed by (13) for frames within the scene, then choosing the maximum element among them.

The scene-based scenario uses information on the total number of scenes Nₛ in the current video and the scene-cut frames f={f₁, . . . , f_{N}_{ₛ}}, where fₘ refers to the frame number of m-th scene and m∈[1, Nₛ]. Note that Nₛ≥1 and f₁=1 so that the first frame is included as one of the scene-cut frames.

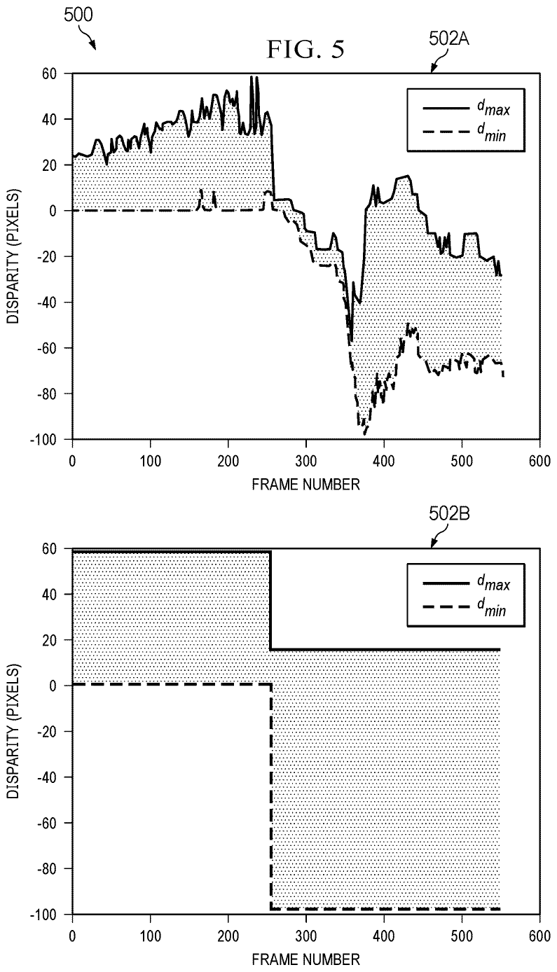

FIG. 5 shows an example of disparity statistics that can be used with one or more embodiments of the invention. In FIG. 5, the content includes two scenes (Nₛ=2) where scene-cut frames were specified as f={1, 257}. The top and bottom curves each represent dₘₐₓ and dₘᵢₙ for each frame, respectively. As can be seen from 502B, the disparity statistics generated for scene-based scenario show consistent tendency throughout the scene, which will enable more stable and consistent viewing experience once processed on the decoder side. In contrast, in 502A, the disparities tend to change frame by frame.

While in one embodiment, an encoder can compute the frame disparities using any type of methods, described below are two possible methods for computing the frame disparities. In one embodiment, a key process for computing disparities from given left and right views is to identify the matching points. For example, and in one embodiment, the Speeded Up Robust Features (SURF) is a highly relevant descriptor that are used in various computer vision tasks such as object recognition, object tracking, and image registration. The features can be used to retrieve the locations of matched points from left view and right views. Depending on the contents of each k-th frames, this number of matched points may vary in which was denoted as Nₖ. The disparities within the frame can be collected by taking differences between the horizontal coordinates of the matched points using (8). Each disparity is denoted as s_{(k,l)} which refers to the disparity of the l-th matched point in the k-th frame. The unit of the disparities are in pixels. In one embodiment, this considers horizontal disparities on the assumption that properly rendered stereo contents are rectified so that the corresponding points have same row coordinates. In case where the stereo content does contain vertical disparities, the content would be stereo-rectified prior to encoding or extracting disparity statistics.

The SURF method described above provides disparity statistics for the matched points only and not on every pixel of the frames. While this can suffice for the encoder, there may be other applications that would use a pixel-wise disparity map. For such cases, an alternative way can be used that is based on the Semi Global Matching (SGM) method. The method generates a dense disparity map by measuring the similarities of each pixel in one stereo view to pixels within a subset of the other stereo view. The pixel matching is performed based on the similarity cost between the pixels with some regularization term that enforces smoothness on the disparity surface. One issue of the implementation is that it takes the DisparityRange of the stereo content as input and the accuracy of the generated disparity map is highly dependent on it. However, since the range is not known a priori as such manual operation is not desirable, the HYBRID approach can be used where the DisparityRange parameter is first auto-extracted using the SURF based method discussed earlier and the range is fed into the SGM based method to generate a disparity map.

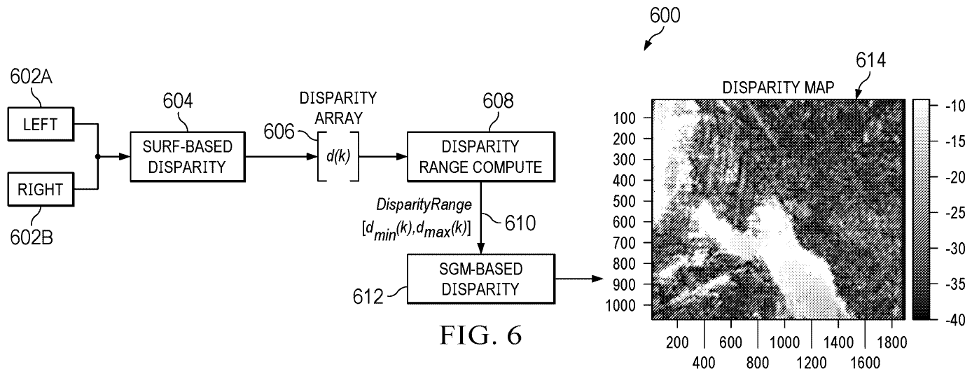

FIG. 6 shows, in a flow diagram, an example of a HYBRID disparity extraction method that can be used with one or more embodiments of the invention. Disparity statistics can be also obtained from this HYBRID method that use the same equations (12) and (13), but the statistics are from richer set of data which is based on all pixels in the frame instead of matching points of SURF features. In FIG. 6, the left and right video streams (602A-B) are provided to a SURF disparity process 604 (as described above) that determines a disparity array [d(k)] 606. The disparity ranges are computed (608) to give [dₘᵢₙ(k), dₘₐₓ(k)] 610. This disparity range matrix 610 is processed using an SGM-based disparity (612) that results in the disparity map 614.

One of the initial operations on the decoder side derive comfort zone thresholds appropriate for current viewing condition. The Comfort Zone Analyzer module fetches the viewing condition parameters, computes the comfort zone thresholds (sₙₑₐᵣ, s_{far}), and sends them to the Scale/Shift Parameter decision module. Discussed below are how these disparity thresholds are derived.

In (10) and (11), it is shown how sₙₑₐᵣ and s_{far} are affected by viewing condition parameters such as IPD and screen distance (d_{f}). However, the thresholds were provided in the unit of meters. These thresholds can be converted to the unit of pixels since it is more intuitive to understand and control the disparities of the contents accordingly. For the unit conversion, two more viewing condition parameters may be needed that are the horizontal screen size in meters (Wₘ) and the horizontal pixel resolution per each screen (Wₚ). In the case of an HMD, Wₘ refers to the dimension of the virtual screen and not the dimension of the actual physical screen. The unit conversion is done as follows.

$${s}_{far} [ pix ] = \frac{{s}_{far} [ m ]}{{W}_{m} [ m ]} \times {W}_{p} [ pix ] \qquad ( 14 )$$

$${s}_{near} [ pix ] = \frac{{s}_{near} [ m ]}{{W}_{m} [ m ]} \times {W}_{p} [ pix ] \qquad ( 15 )$$

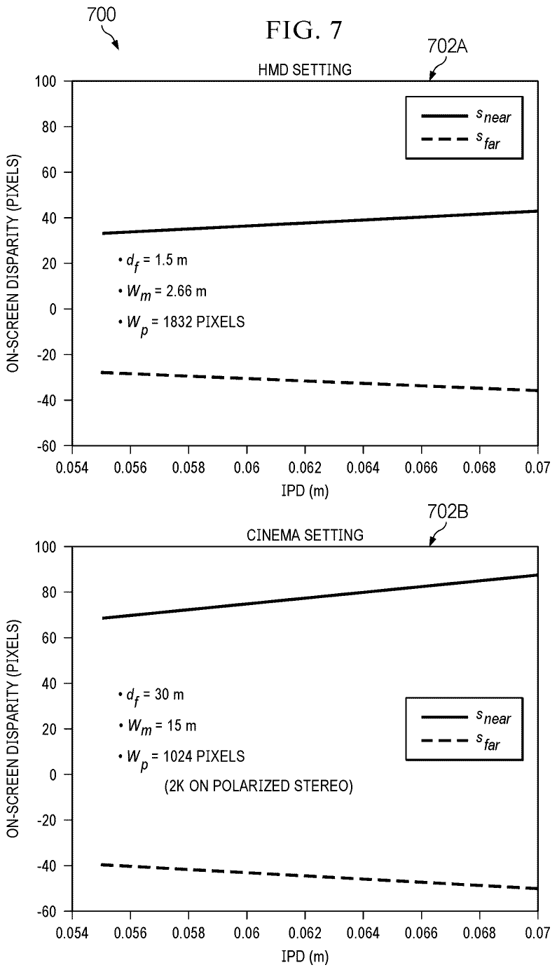

FIG. 7 shows an example of comfort zone disparities 700 on different viewing conditions that can be used with one or more embodiments of the invention. The top curves of plots 702A-B indicate positive conflict threshold sₙₑₐᵣ which happens at positive disparities. The lower curves of plots 702A-B indicate negative conflict thresholds s_{far} which happens at negative disparities. The thresholds are in the unit of pixels. The top plot 702A indicates zone of comfort for an HMD device, where it can be seen that the comfort zone disparities for average IPD (63 mm) are those that lie between-32 to 38 pixels. The bottom plot 702B indicates zone of comfort for stereo cinema viewing condition. In this case, the comfort zone disparities for average IPD (63 mm) are those that lie between-45 to 78 pixels. As can be seen from the results, comfort zone threshold numbers vary depending on viewing conditions. This means that content optimized for a certain viewing condition may cause discomfort on others, which again emphasizes the need of viewing condition-adaptive disparity control framework described herein.

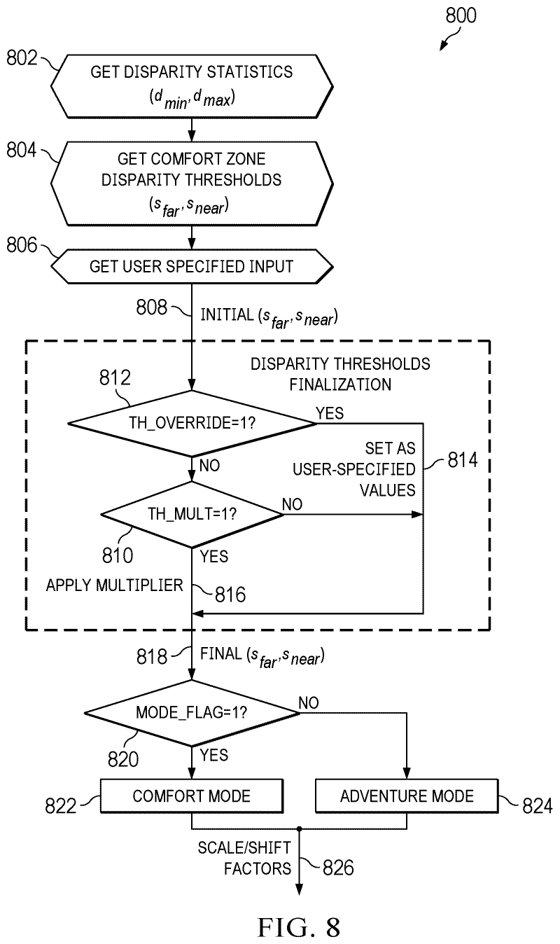

In one embodiment, the scale/shift parameter decision process is an important part of the decoder that determines the appropriate scale/shift factors to apply on the stereo content for disparity control. FIG. 8 shows, in a flow diagram, an example of a scale/shift parameter decision process 800 that can be used with one or more embodiments of the invention. In FIG. 8, process 800 begins by receiving the disparity statistics (dₘᵢₙ, dₘₐₓ) from the input stream (802), initial comfort zone thresholds (s_{far}, sₙₑₐᵣ) from the Comfort Zone Analyzer (804), and the user specified input from the device side application (806) which include mode information and control parameters for comfort zone thresholds.

In one embodiment, a user may (1) use the thresholds computed from the Comfort Zone Analyzer module as is, (2) set multipliers to be applied on the thresholds to widen out or reduce the comfort zone ranges, (3) or override with the values they specify. In the case of override, the threshold values must be specified in unit of pixels. In this proposed framework, these disparity thresholds play essential role in controlling stereo disparities for increased sense of comfort or depth (depending on comfort or adventure mode). While the thresholds provided from the Comfort Zone Analyzer module can be based on perceptual parameters derived from a human study, these thresholds are based on the average response of the participants of the study. As people's sensitivity to stereo comfort or depth may vary, additional flexibility to control the threshold from the user side can be used if needed. Process 800 determines if the user has set a threshold override at 808. If there is a threshold override, process 800 sets the user specified values as the threshold for (s_{far}, sₙₑₐᵣ) (814). If not, process 800 proceeds to determine if a threshold multiplier is to be applied at 810. If a threshold multiplier is to be applied, process 800 applies the threshold multiplier to the initial thresholds (816). If no multiplier is to be applied, execution proceeds to 820.

At 820, process 800 receives the final (s_{far}, sₙₑₐᵣ) (818) and determines what mode is used for the HMD. In one embodiment, the modes can be one of Adventure mode or Comfort mode. In a further embodiment, process 800 determines a mode flag to determine whether the mode selected is adventure or comfort. After the comfort zone disparity thresholds are finalized, the module takes one of the two branches of operations (822 or 824) based on the user's specification on the operation mode. Again, two modes of operations are provided, denoted as comfort mode and the adventure mode. The comfort mode (822) is used to reduce the disparity of the content. It can be used for contents with disparities that deviates out of comfort zone ranges, where the mode can control the disparities into the comfort zone ranges. As described above, the usage of comfort mode is not limited to the scenario and can still be operated even when disparities are within the comfort zone by user specification. In a further embodiment, the adventure mode (824) can be used to increase the disparity of the content. The adventure mode can also be used for contents with very small disparities that are already safely inside the comfort zone, where the mode can be used to bring the disparity statistics closer to either of the positive or negative disparity threshold, but not crossing it, to provide increase sense of depth while not introducing discomfort. The usage of adventure mode is not limited to the scenario and can still be operated even when disparities are already outside the comfort zone, if specified by the user.

In one embodiment, the user inputs for the scale/shift parameter decision can be part of threshold control and mode determination. In this embodiment, the user inputs for threshold controls can be threshold override, user far threshold, user near threshold, user specified threshold multiplier usage, and multiplier. For example, and in one embodiment, threshold override specifies the usage of the user specified thresholds. For example, the value can be 0 or 1. The value 0 indicates that no threshold is specified from the user side. The value 1 indicates that the user has specified SF_U and SN_U which each corresponds to the user specified s_{far} and sₙₑₐᵣ, respectively. The default value is 0.

The user far threshold refers to the s_{far} value specified by the user in pixel units. The value shall be in the range of −W to 0, where W refers to the width of one of the views of the stereo video. Note that the value is less than or equal to zero since it deals with the negative conflict case and the value is bounded by −W since it is the largest negative disparity possible from the given input video resolution. The default option is not to send the value.

The user near threshold refers to the sₙₑₐᵣ value specified by the user in pixel unit. The value shall be in the range of 0 to W, where W refers to the width of one of the views of stereo video. Note that the value is greater than or equal to zero since it deals with the positive conflict case and the value is bounded by W since it is the largest positive disparity possible from the given input video resolution. The default option is not to send the value.

The user specified threshold multiplier usage specifies the usage of the user specified multiplier. The value shall be 0 or 1. The value 0 indicates that no multipliers have been specified from the user side. The value 1 indicates that user have specified M_U which corresponds to multiplier to be applied on s_{far} and sₙₑₐᵣ provided from the Comfort Zone Analyzer module. The default value is 0.

Multiplier refers to the multiplier to be applied on s_{far} and sₙₑₐᵣ provided from the Comfort Zone Analyzer module. The value shall be in the range of 0.25 to 4, where values less than 1 reduces the range, thereby moderating the comfort zone to be more conservative. The values greater than 1 increases the comfort zone range, thereby allowing greater disparities and greater sense of depth. The default option is not to send the value.

For the mode determination, a mode flag serves as a flag for which mode of operation to use. The value shall be 0 or 1. In one embodiment, the value of 0 indicates that the adventure mode and the value of 1 indicates the comfort mode. The default value is 1. In a further embodiment, there can be more than two modes, in which the flag is replaced with an indicator of which mode to use.

With the comfort zone disparity thresholds determined, the next step is to get the disparity statistics of the content and apply the scale/shift on the left/right views to control the disparities according to the mode of operation specified by MODE_FLAG. Before going into the procedures for each mode, how the scale/shift affects the disparities is discussed.

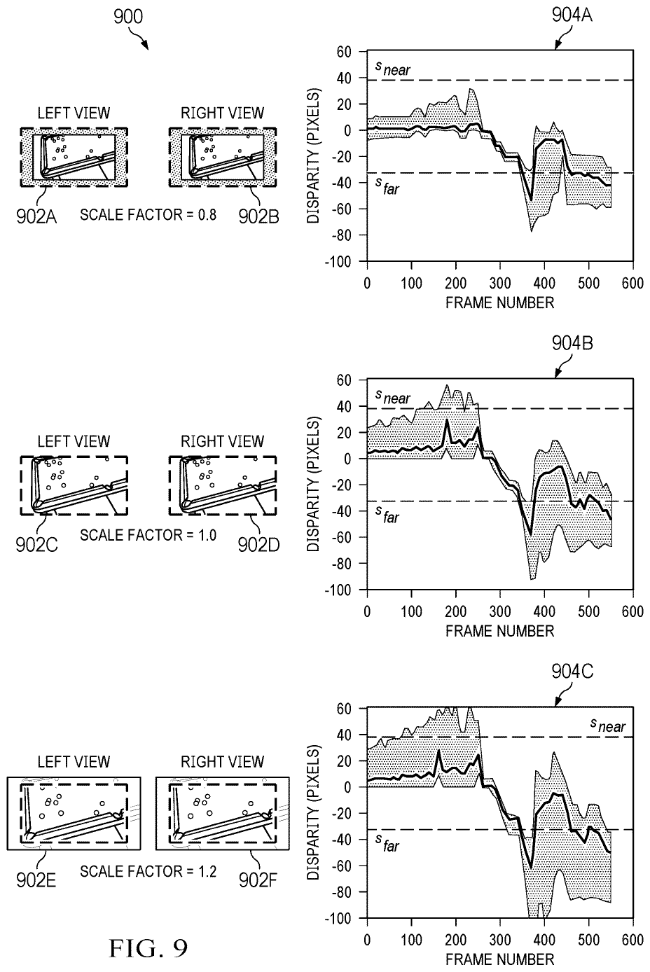

FIG. 9 shows an example of an effect 900 of scale on the disparity statistics that can be used with one or more embodiments of the invention. In FIG. 9, an illustration of the cases of scaling both the left and right view to different scale factors of 0.8, 1.0, and 1.2. The shaded boxes in the images 902A-F depict the region to be displayed on the screen. This can scale both horizontal and vertical dimension of the video to maintain the aspect ratio of the original content. For example, and in one embodiment, a scale factor of 0.8 scales down the size of the image (e.g., 902A and 902B) from the original size (e.g., illustrated with scale factor of 1.0 in 902C and 902D). In one embodiment, scaling the stereo views to a factor smaller than 1 can introduce black border areas. These black borders may not be as bothering considering that video players in HMDs, in general, displays black color on the peripheral area that are not part of the virtual screen. However, it is still not desirable to have these black borders as they may be noticeable if there are cases of applying very different scale factors on consecutive scenes or frames. In terms of disparity statistics, FIG. 9 illustrates that the disparity range (904A), overall, has condensed into the comfort zone from both positive and negative disparity directions when compared to that of a scale of 1.0 (904B). This is expected since a global scale factor is applied on both stereo views, and the disparities defined as in (8) will also reduce in magnitudes according to the applied scaling factor. Such scaling factors less than 1 can be helpful in controlling the disparities causing negative and/or positive conflicts into the comfort zone.

Conversely, by having a scale factor greater than 1 could cause the image to be cropped. For example, with a scale factor of 1.2, the image is enlarged by the scale factor. In one embodiment, scaling the stereo views to a factor larger than 1 can introduce a cropped-out area. It is again not desirable to have too much of these cropped out area since contents from original scenes can be lost. In terms of disparity statistics, FIG. 9 illustrates (904C) that the disparity statistics stretched out to both positive and negative disparity directions compared to the disparity statistics of a scale 1.0 (904B). Again, this is due to the global shift factor that stretched out the coordinates, which in turn, scaled the disparity magnitude to be larger. Applying such scaling factor larger than 1 can be helpful in case of adventure mode where it may be needed to stretch out the small magnitude disparities closer to the disparity thresholds.

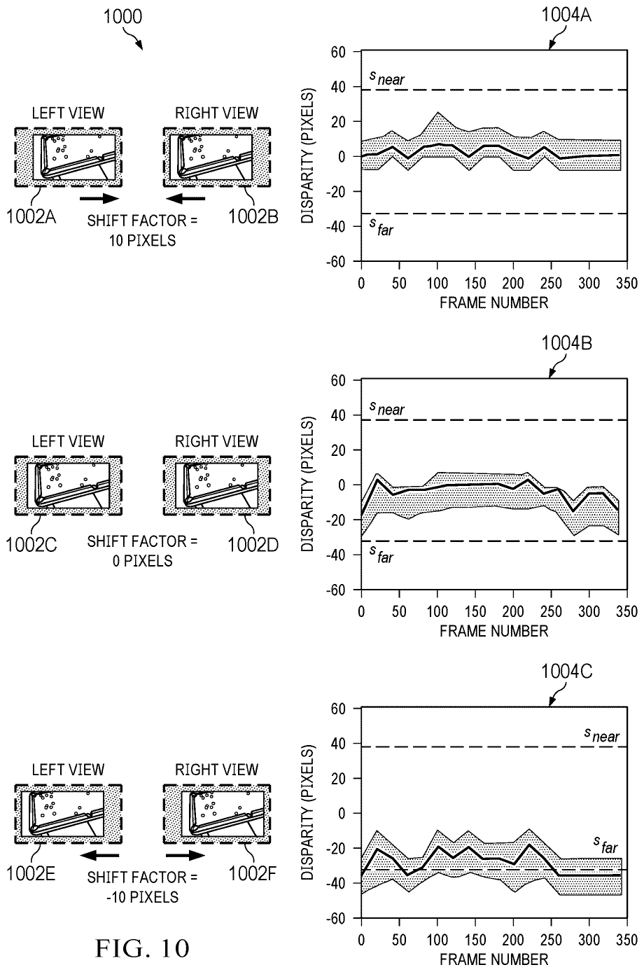

FIG. 10 shows an example of an effect of shift on the disparity statistics that can be used with one or more embodiments of the invention. In FIG. 10, cases of incorporating shift factors with the scale factor are depicted (1002A-F). The stereo views were first scaled by the factor of 0.9, then different shift factors of −10 (1002A-B), 0 (1002C-D), and 10 pixels (1002E-F) were applied. Unlike the scale case where identical operations on both views are applied, the shift amount applies in opposite directions for each view to either pull or push away from each other. In one embodiment, because shift factors are set in the aspect of the left view, positive number means pulling the two views closer together while negative number means pushing the two views far away from each other. As can be seen from the disparity statistics (1004A-C), the shift factor variation cannot condense or stretch the range of disparities but tend to shift the whole disparities upwards or downwards.

In one embodiment, despite its limitation on disparity control, it is worth noting that the shift operation can be applied without further increasing black borders or cropped area if (1) it is applied after the scale operation and (2) if the shift amount resides in the buffers created from scale operations. Therefore, proper combinations of scale shift operations can shape the disparity statistics into a desired direction while minimizing the black borders or cropped area, which is an optimization problem that will be discussed below.

In one embodiment, how scale and shift factors affect the disparities is numerically analyzed. Let s₁ and s₂ denote scale and shift factor, respectively. Let o_{w} denote horizontal offset to maintain the center of the image after the scaling operation which is formulated as

$${o}_{w} = \frac{( 1 - {s}_{1} ) W}{2} \qquad ( 16 )$$

where W refers to the width of the one of the views of stereo video. Note that o_{w} can be a negative number if s₁>1. Denote Cₗ as the horizontal coordinates of a certain point from the left view, and Cᵣ as the horizontal coordinates of the corresponding point on the right view. If the scale and shift (s₁, s₂) operations are applied on the stereo views, the transformed horizontal coordinates Ĉₗ and Ĉᵣ for the left and right views are expressed as

$${\hat{C}}_{l} = {s}_{1} {C}_{l} + {o}_{w} + {s}_{2} \qquad ( 17 )$$

$${\hat{C}}_{r} = {s}_{1} {C}_{r} + {o}_{w} - {s}_{2} \qquad ( 18 )$$

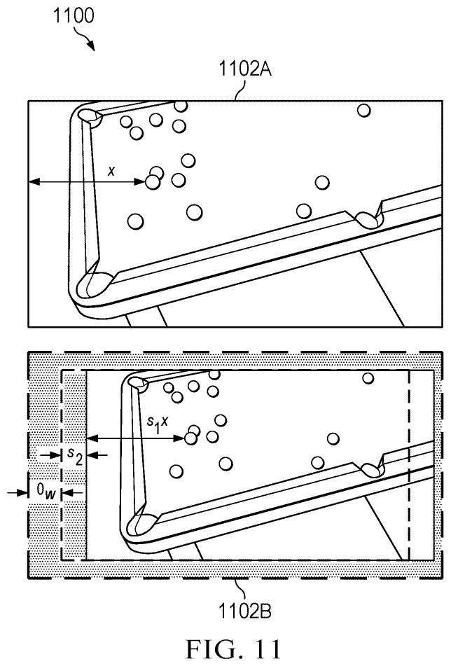

Note that the shift factor s₂ is applied in opposite directions for each view. FIG. 11 shows an example of a visualization of original and applied horizontal coordinate that can be used with one or more embodiments of the invention. In one embodiment, FIG. 11 visualizes the equation (17). In FIG. 11, image 1102A has the distance x, which is the original horizontal coordinate to a ball (distance x). The inside dashed box of image 1102B indicates where center aligned scaled image should have been located. As can be seen from the figure, the image is further shifted to the right due to the shift factor s₂. In such case, a new horizontal coordinate to the ball becomes s₁x+o_{w}+s₂ as in (17).

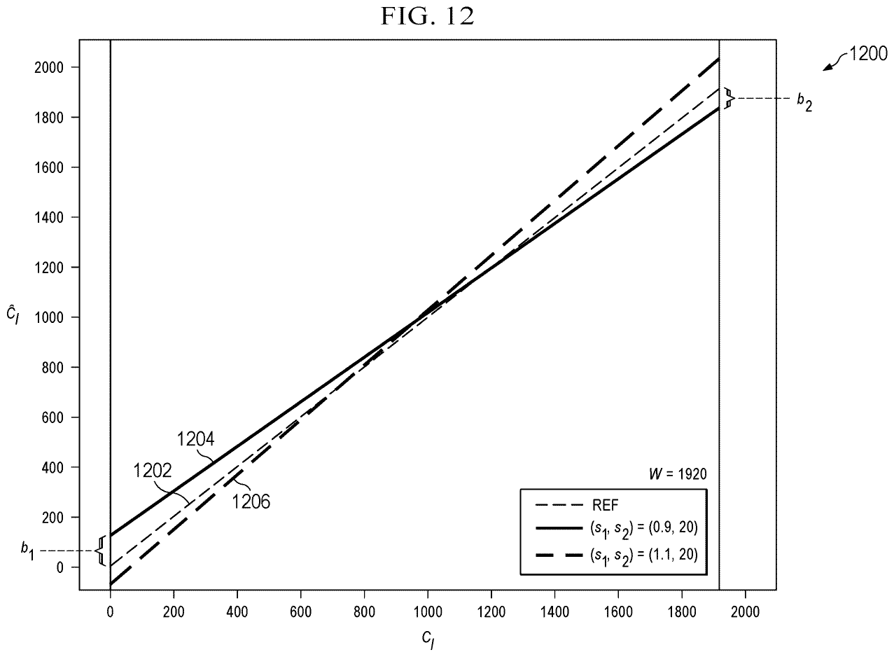

FIG. 12 shows an example of original and transformed horizontal coordinates that can be used with one or more embodiments of the invention. In one embodiment, FIG. 12 illustrates plots of the original (Ct) and transformed (Ct) horizontal coordinates of the left view at various scale/shift factors (s₁, s₂). The dashed curve 1202 indicates a reference curve where Ĉₗ=Cₗ. The solid curve 1204 indicates case where (s₁, s₂)=(0.9, 20). Since it is the case where s₁<1, it will introduce black borders. This is presented as b₁ and b₂ which are the differences between the reference (1202) and solid (1204) curves at Cₗ=0 and Cₗ=1920. Similarly, the heavy dashed curve 1206 indicates a case where (s₁, s₂)=(1.1, 20). Since it is the case where s₁>1, it will introduce cropped out regions. Again, this cropped out regions are indicated as the differences between heavy dashed (1206) and reference curve (1202) at Cₗ=0 and Cₗ=1920.

In one embodiment, following the disparity definition in (8), the disparities (d) of corresponding points in the stereo view can be computed by

$$d = {C}_{l} - {C}_{r} \qquad ( 19 )$$

Similarly, the disparities (\hat{d}) of the corresponding points of the transformed stereo view can be computed as

$$\hat{d} = {\hat{C}}_{l} - {\hat{C}}_{r} \qquad ( 20 )$$

Plugging (17) and (18) to (20) gives

$$\hat{d} = {ds}_{1} + 2 {s}_{2} \qquad ( 21 )$$

which demonstrates the relationship between the original disparity (d) and scale/shift applied disparity (\hat{d}).

The previous section, from (21), shows how on-screen disparities can be controlled by appropriate choices of (s₁, s₂). However, this equation (21) holds accurate in a perceptual sense only if the full screen contents are present to a user's eyes. For instance, even if the on-screen disparities as desired are controlled, if only a partial region of the screen of each view are present to a user's eyes, the perceived disparity (or depth) would be different from what was intended.

The range of screen viewable to a user's eyes is relevant because recent HMDs provide a function to adjust the lens distance. While this function gives flexibility to adapt to people with different IPDs, it may affect the field of view (FOV). So, in this section, whether different IPDs affect FOV enough so that it limits the range of screen reaching a user's eyes is reviewed.

A properly designed HMD hardware assumes that the lens focal length and the lens location are properly set so that it covers all physical screen range. Let horizontal dimension of the physical screen of the HMD be w′. Then, the screen viewed on one of a user's eyes is of length w′/2. This screen can be further divided into two segments of

$${w}_{1}^{′} = \frac{ipd}{2} \qquad ( 22 )$$

$${w}_{2}^{′} = \frac{{w}^{′} - ipd}{2} \qquad ( 23 )$$

where

$${w}_{1}^{′}$$

refers to the screen region ranging from the center of the pupil to the nasal direction until it meets the slit dividing the left/right view. The angle formed by this region is denoted θ₁. The

$${w}_{2}^{′}$$

refers to the screen region ranging from the center of the pupil to the ear direction until it meets end of the physical screen. Denote the angle formed by this region θ₂. Let w₁ and w₂ denote the virtual screen generated by the physical screens

$${w}_{1}^{′} and {w}_{2}^{′} ,$$

respectively, where the dimensions are simply the magnification factor (M) multiplied on its respective physical screen size. The screen region that are shown at current IPD can be formulated as

$${w}_{1} + {w}_{2} = \frac{M ( ipd )}{2} + \frac{M ( {w}^{′} - ipd )}{2} = \frac{{Mw}^{′}}{2} \qquad ( 24 )$$

The FOV formed at current IPD is formulated as

$${θ}_{1} + {θ}_{2} = {tan}^{- 1} ( \frac{M ( ipd ) / 2}{{d}_{f}} ) + {tan}^{- 1} ( \frac{M ( {w}^{′} - ipd ) / 2}{{d}_{f}} ) \qquad ( 25 )$$

where d_{f} is the distance to the virtual screen.

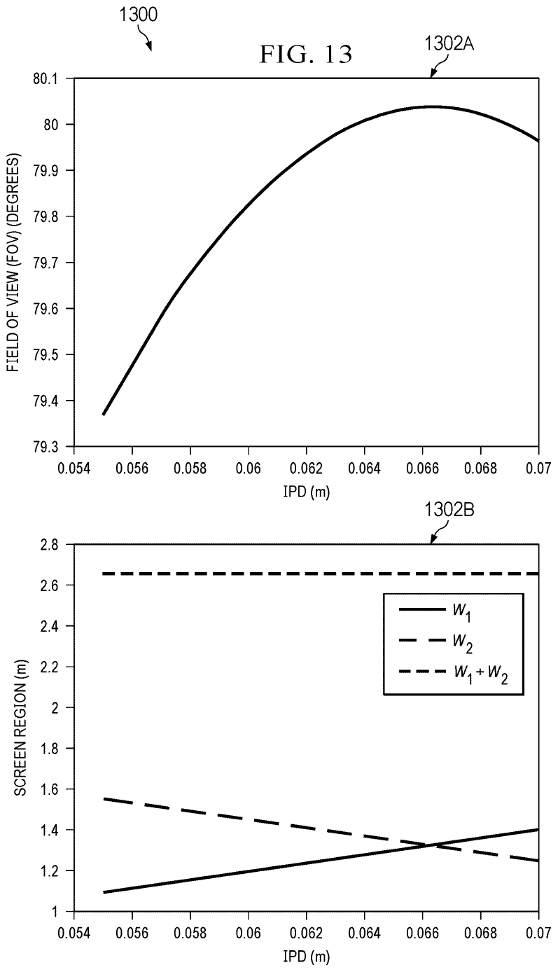

FIG. 13 shows an example of an effect of IPD on FOV and screen region that can be used with one or more embodiments of the invention. In one embodiment, FIG. 13 illustrates a plot 1302A on how IPD may alter FOVs slightly, but the magnitude difference is not significant, maintaining 79~80 degree of FOV over wide range of IPDs. Plot 1302B illustrates how on different IPDs, the screen regions shown to the eyes are constantly at full range. This is also shown in FIG. 13 where the effect of IPD cancels out from the equation. The conclusion here is that changing the lens distances based on different IPDs may slightly alter FOV, but the effect is miniscule. More importantly, even on different lens distances, the HMD will be presenting full screen content on left/right views. This means that on-screen disparity control based on Equation (21) will give the desired effect perceptually as well.

After the comfort zone disparity thresholds (s_{far}, sₙₑₐᵣ) are finalized, the scale/shift parameter decision process either takes the branch of Comfort or Adventure mode. The Comfort Mode procedure is activated when MODE_FLAG=1 from the User Specified Input. The goal of this mode is to derive appropriate choices of (s₁, s₂) to apply on scenes or frames so that (dₘᵢₙ, dₘₐₓ) are controlled to stay within the range of s_{far}~sₙₑₐᵣ without causing any viewing discomfort from negative and/or positive conflict.

As illustrated in FIG. 9 above, s₁<1 effectively condenses the disparity range into the comfort zone. In this embodiment, this scaling can create black borders that can be undesirable. In addition, applying s₂ on the scaled frame provides additional control on the disparities while not introducing additional black borders if operated within the dimensions of already introduced black borders from the scaling factor. Using these properties, this can be formed an optimization problem that searches for a (s₁, s₂) that minimizes the black border area while bringing the disparities to the comfort zone.

Let b(⋅) denote function that outputs the black border area from the given (s₁, s₂). The black border area here are provided in number of pixels. The problem is formulated as

$${minimize}_{{s}_{1} , {s}_{2}} b ( {s}_{1} , {s}_{2} ) \qquad ( 26 )$$

$$subject to {s}_{1} {d}_{max} + 2 {s}_{2} \leq {s}_{near} \qquad ( 27 )$$

$${s}_{2} {d}_{min} + 2 {s}_{2} \geq {s}_{far} \qquad ( 28 )$$

$$0 \leq {s}_{1} \leq 1 \qquad ( 29 )$$

where (27) and (28) are conditions for having maximum and minimum disparities to reside within the comfort zone of range s_{far}~sₙₑₐᵣ after controlling the disparities using (s₁, s₂) as in (21). Condition (29) is to condition the scale factor to be less than 1 which is what will be used for the Comfort Mode.

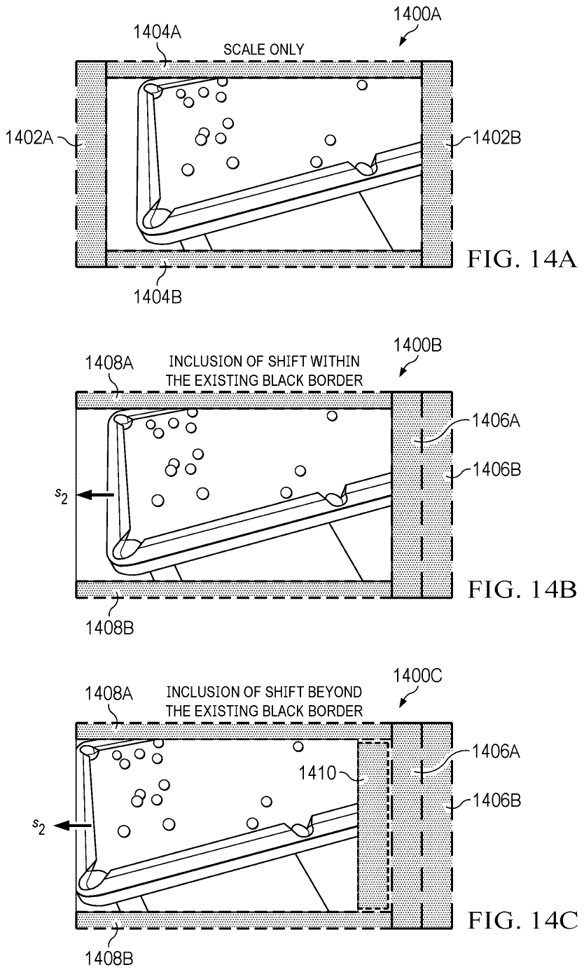

FIGS. 14A-C shows examples of a set of scale and shift factors applied to a video frame that can be used with one or more embodiments of the invention. In FIGS. 14A-C, a video frame (1400A-C) is scaled (1400A), shifted that is within the existing border (1400B), or shifted beyond the border (1400C). In formulating b (⋅), following cases should be considered. (1) Scale only: when only scaling factor s₁ is applied. In such case, the introduced shaded border areas in boxes 1402A-B and boxes 1404A-B is formulated as

$${b}_{1} ( {s}_{1} ) = ( 1 - {s}_{1}^{2} ) HW \qquad ( 30 )$$

where H and W refer to height and width of the views respectively.
(2) Inclusion of a shift (1400B) within an existing shaded border: the shift factor s₂ is applied after s₁ and |s₂|≤|(1−s₁)W/2|. In other words, the shift magnitude is within the dimension of the shaded borders introduced by scaling. In such case, the black border areas (1406A-B and 1408A-B) are maintained as (30).
(3) Inclusion of a shift (1400C) within an existing black border: | s₂|>|(1−s₁)W/2|. In other words, the shift magnitude exceeds the dimension of the black borders introduced by scaling. In such case, one or more additional shaded border areas indicated in box 1410 can be introduced which is formulated as

$${b}_{2} ( {s}_{1} , {s}_{2} ) = ( \vert {s}_{2} \vert - \vert \frac{( 1 - {s}_{1} ) W}{2} \vert ) {s}_{1} H \qquad ( 31 )$$

Comprehensively, b(⋅) is formulated as

$$b ( {s}_{1} , {s}_{2} ) = \{ \begin{matrix}{b}_{1} ( {s}_{1} ) , & \vert {s}_{2} \vert < \vert \frac{( 1 - {s}_{1} ) W}{2} \vert , \\ {b}_{1} ( {s}_{1} ) + {b}_{2} ( {s}_{1} , {s}_{2} ) , & otherwise\end{matrix} \qquad ( 32 )$$

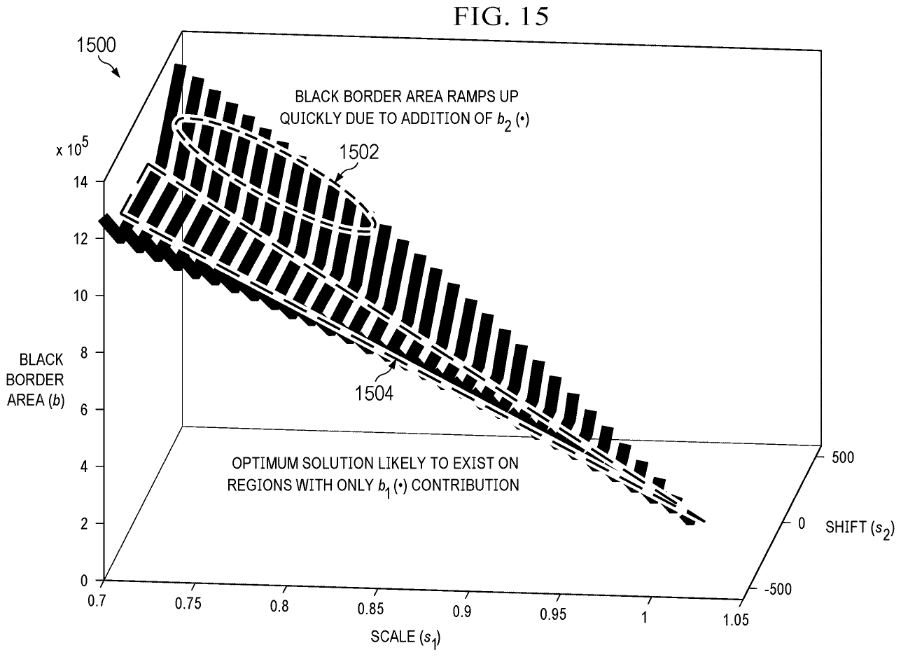

FIG. 15 shows an example of a plot of black border that can be used with one or more embodiments of the invention. In one embodiment, FIG. 15 illustrates a plot of black border area b on varying (s₁, s₂). As can be seen from the circled part of the figure (1502), at any fixed s₁, if |s₂| exceeds |(1−s₁)W/2| the black border area ramps up quickly. Considering that the optimum solution (1504) will be (s₁, s₂) that gives minimum black border area while satisfying (27) and (28), it is highly likely that the solution will exist on area indicated in region(s) with only b₁ contribution.

A simple approach of finding the solution for (26) is to perform a full grid search using a full grid search process. For instance, the (s₁, s₂) combinations can be set to try as below.

In one embodiment, the approach sets (s₁, s₂) search candidates. In this embodiment, (s₁, s₂) is initially set as such:

$${s}_{1} = {s}_{bound} : 0.001 : 1 , where {s}_{bound} = 0.7$$

$${s}_{2} = - m : 1 : m , where m = round ( \vert \frac{( 1 - {s}_{1} ) W}{2} \vert )$$

In one embodiment, the lower bound for s₁ by 0.7 to avoid cases of down sampling the views to considerably lower resolution. This lower bound can be changed as needed. Note that the search range of s₂ is set to be dependent on s₁ as

$$\vert {s}_{2} \vert \leq \vert \frac{( 1 - {s}_{1} ) W}{2} \vert ,$$

since, as demonstrated in FIG. 14, the optimal solution is likely to lie on such region with only b₁ contribution to the black border area. Also note that the step size of s₁ is set to be a small value of 0.001 to allow high precision on the grid search (although in different embodiments, different step sizes can be used). In this embodiment, this high precision is of paramount importance for obtaining the most optimal solution, since (1) as the optimization problem aims for the least black border area, the s₁ value of the optimal solution will be driven to larger values and (2) on those considerably large s₁ (close to 1) even the small differences of 0.001 gives room for s₂ to shift a few more pixels that may help meet condition (27) and (28). It is also shown from the experimental result section that the optimal solutions often require control on the scale factors with precision at (or higher than) third decimal digit. Such precision setting yields ~87K combinations of (s₁, s₂).

After determining possible combinations of (s₁, s₂), a table for black border area is constructed: Considering that the black border area is deterministic with given (s₁, s₂), the black border areas can be pre-computed and stored as a table instead of computing it every time. The generated table T_{b} is stored and is loaded up when the decoder initializes. There are ~87K rows with each row consisting of three numbers. If stored in double precision which is 8 B, the memory size required is ~2 MB.

Once the required information of (s_{far}, sₙₑₐᵣ) and (dₘᵢₙ, dₘₐₓ) becomes available, the full grid search process loops through the (s₁, s₂) combinations on T_{b} to find ones that meets (27) and (28). Whenever the full grid search process meets such condition, the full grid search process checks on the black border area of the corresponding (s₁, s₂) by referring to T_{b} and update it as the optimal scale/shift solution if it gave smaller black border area compared to the ones so far.

Even though the full-search method described above provides a simple way to derive optimal solutions, it requires searching through high numbers of (s₁, s₂) candidates (~87K) and some memory requirements (~2 MB) for loading T_{b} which contains the pre-computed black border areas. The number of candidates and memory requirement can grow even higher in case of trying higher precision or wider search range of s₁.

In this section, an Efficient-search solution that alleviates these issues is proposed. The proposed method does not require any explicit black border area computations or any loading of pre-computed tables on them. It also performs much fewer number searches (576 searches, if s_{bound}=0.7) and is still able to find an optimal solution that gives similar or less black border area compared to the Full-search method.

The Efficient-search method achieves this by deriving a closed form solution of optimal s₁ as a function of s₂. By doing so, an efficient search process does not need to multiplicatively increase the number of search candidates for the sake of s₁ precision, since the solution is derived mathematically. Instead, the efficient search process just needs to sweep through a certain search range of s₂ which is much less than the Full-search case.

In one embodiment, the problem formulation is revisited. As demonstrated earlier in FIG. 15, the solution will lie on (s₁, s₂) space where black border areas are contributed only by b₁. Therefore, the problem can be set as

$${minimize}_{{s}_{1} , {s}_{2}} {b}_{1} ( {s}_{1} ) = ( 1 - {s}_{1}^{2} ) HW \qquad ( 33 )$$

subject to (27), (28), (29), AND additionally including

$$\vert {s}_{2} \vert \leq \frac{( 1 - {s}_{1} ) W}{2} \qquad ( 34 )$$

Unlike (26), here b₂(⋅) is not added to the objective function but is added to the constraint (34) to limit the objective function with only b₁(⋅) contribution as in (33).

Considering that b₁(⋅) is a monotonically decreasing function on 0≤s₁≤1, it is favorable to have the largest possible s₁ that meets all the constraints. Therefore, cases where constraints define upper bound for s₁ are identified which are shown in Table 1. Here, the set containing upper bound candidates for s₁ is denoted as U.

With constraints on the upper bound determined, a closed form solution for s₁ can be derived. Considering that b₁(⋅) is a monotonically decreasing function on 0≤s₁≤1, it is favorable to have the largest possible s₁ that meets all the constraints. Therefore, cases can be identified where constraints define upper bound for s₁ that is shown in Table 1. Here, the set containing upper bound candidates for s₁ is denoted as U.

TABLE 1
Deriving upper bound candidates for s₁ from given constraints

| Constraints | Upper bound candidates |
|---|---|
| (26) | U = {1} |
| (24) | $If {d}_{max} > 0 , U = U ⋃ \{ \frac{{s}_{near} - 2 {s}_{2}}{{d}_{max}} \}$ |
| (25) | $If {d}_{min} < 0 , U = U ⋃ \{ \frac{{s}_{far} - 2 {s}_{2}}{{d}_{min}} \}$ |
| (31) | $If {s}_{2} \geq 0 , U = U ⋃ \{ 1 - \frac{2 {s}_{2}}{W} \}$ |
| | $If {s}_{2} < 0 , U = U ⋃ \{ 1 + \frac{2 {s}_{2}}{W} \}$ |

Once the upper bound candidates are collected from all the constraints, the optimal s₁ can be obtained by

$${s}_{1}^{*} = min ( U ) \qquad ( 35 )$$

In one embodiment, Eq. (35) takes the minimum among the upper bound candidates to find one that meets all the imposed constraints. Note that many of the candidates of U are functions of s₂, which makes the solution not perfectly closed. But assuming that s₂ is given, the expression (35) gives the corresponding optimal s₁ that minimizes the optimization function in (33).

With the minimization completed, an optimal (s₁, s₂) through an s₂ sweep is derived. Now that the derived close form solution of s₁ as a function of s₂ is determined, the last step is to sweep through range of s₂. The range can be set by using

$$\vert {s}_{2} \vert \leq \frac{( 1 - {s}_{bound} ) W}{2}$$

by are avoiding the cases of down sampling the views to a factor lower than s_{bound}. In case of s_{bound}=0.7 on FHD stereo video (W=1920), the s₂ sweep range becomes [−288, 288]. For each s₂, a corresponding s₁ that minimizes the black borders can be derived using (35). Among them, the (s₁, s₂) pair with the largest s₁ value is chosen since it minimizes the objective function of (33).

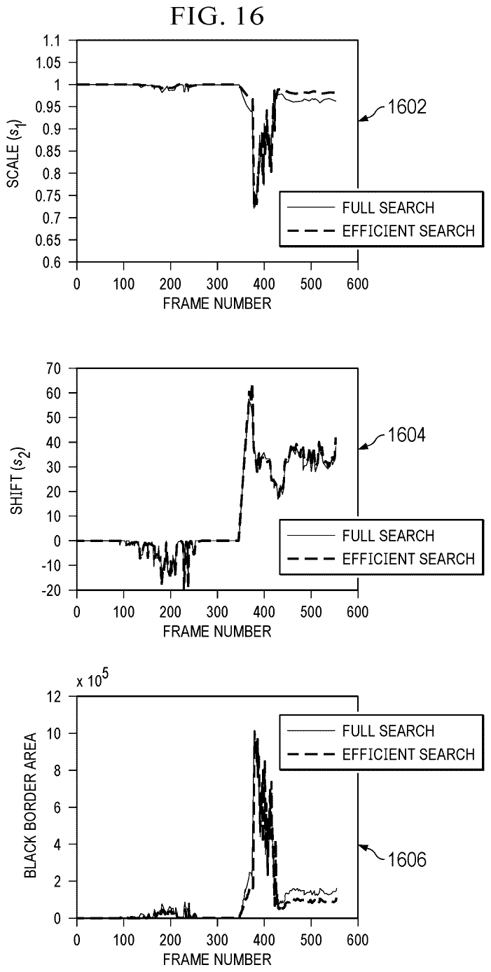

FIG. 16 shows an example of a comparison of optimal scale factor, optimal shift factor, and black border area that can be used with one or more embodiments of the invention. In one embodiment, FIG. 16 illustrates the optimal scale factor (s₁) (1602) and optimal shift factor (s₂) (1604) derived on example content using Full-search and Efficient-search method. The frame based (dₘᵢₙ, dₘₐₓ) arrays from the encoder side is sent to finely examine the differences of decisions of each search methods and used s_{bound}=0.7 for both methods. As can be seen from FIG. 16, both methods derived scale factors that are above the s_{bound} value set. In FIG. 16, there are regions where the Efficient-search derived higher s₁ values compared to Full-search method, which leads to less black border areas in FIG. 16 (1606). This discrepancy can be reduced if lower step size on Full search is employed but it will multiplicatively increase the search numbers and memory requirement. This shows the effectiveness of the Efficient-search method where the method is able to derive optimal solutions with no memory requirements and less number searches. Thus, the Efficient search can be used as a method for deriving optimal (s₁, s₂). The (s₁, s₂) decisions Comfort mode makes on different contents and how they affect disparity statistics are covered.

In one embodiment, the Adventure Mode procedure is activated when MODE_FLAG=0 from the User Specified Input. The mode receives the finalized comfort zone disparity thresholds (s_{far}, sₙₑₐᵣ) and the disparity statistics (dₘᵢₙ, dₘₐₓ) of the content. The goal of this mode is to derive appropriate choices of (s₁, s₂) to apply on scenes or frames so that (dₘᵢₙ, dₘₐₓ) gets as close to either s_{far} Of sₙₑₐᵣ but not crossing it. The mode is intended to maximize sense of depth either in positive or negative disparity directions without causing viewing discomfort from positive or negative conflicts, respectively. Below, the Adventure Mode procedure is formulated as an optimization problem and show how the solution is derived.

As described above, having s₁>1 stretches the disparity range outwards, which can be a desirable property for Adventure mode which need to stretch small magnitude disparities close to the comfort zone disparity thresholds. However, upscaling frames introduce cropped-out area in which that should be minimize since content could be lost from original scenes. Similarly, to the Comfort mode, applying s₂ on the scaled-up frame provides additional control on the disparities while not adding on to the cropped-out area if operated within the dimensions of the introduced cropped-out regions. Thus, this can be formulated this into an optimization problem where the scale and/or shift are applied to stretch and send disparity statistics closer to the comfort zone thresholds while minimizing the occurrence of cropped out area. The Adventure mode can be formulated as

$${minimize}_{{s}_{1} , {s}_{2}} {b}_{1} ( {s}_{1} ) = ( {s}_{1}^{2} - 1 ) HW \qquad ( 36 )$$

$$subject to 1 \leq {s}_{1} \qquad ( 37 )$$

$$\vert {s}_{2} \vert \leq \vert \frac{( {s}_{1} - 1 ) W}{2} \vert \qquad ( 38 )$$

$$\{ \begin{matrix}{s}_{1} {d}_{max} + 2 {s}_{2} = {s}_{near} \\ {s}_{1} {d}_{min} + 2 {s}_{2} = {s}_{far}\end{matrix} \qquad \begin{matrix}( 39 ) \\ ( 40 )\end{matrix}$$

The objective function b₁(⋅) in (36) is now modified to represent cropped-out area from 1≤s₁ as indicated in (37). The range of s₂ that limits the cropped-out area with only b₁(⋅) is now modified accordingly as in (38).

The most notable changes compared to Comfort mode formulation are the conditions (39) and (40). Formerly the Comfort mode aimed at meeting both inequalities (27) and (28) to make sure the extremes of transformed disparities reside inside the zone of comfort [s_{far}, sₙₑₐᵣ]. However, the aim of Adventure mode is different, in that it tries to bring transformed disparities as close as possible to one of the thresholds (sₙₑₐᵣ or s_{far}). Therefore, the conditions have now changed to equalities and either one of (39) or (40) is taken depending on which threshold is closer to the disparity statistics which are determined as below.

$$If \vert {s}_{far} - {d}_{min} \vert \leq \vert {s}_{near} - {d}_{max} \vert \qquad ( 1 )$$

The disparity statistics are closer to s_{far}. Take the constraint (40).

$$If \vert {s}_{far} - {d}_{min} \vert > \vert {s}_{n e a r} - {d}_{max} \vert \qquad ( 2 )$$

The disparity statistics are closer to sₙₑₐᵣ. Take the constraint (39).

In one embodiment, a closed form solution for s₁ is derived. Considering that b₁(⋅) in (36) is a monotonically increasing function on 1≤s₁, it is favorable to have the smallest possible s₁ that meets all the constraints. Therefore, cases can be identified where constraints define lower bound or equality condition for s₁ as shown in Table 2 below. This is denoted as the set containing lower bound or equality condition for s₁ as L.

TABLE 2
Deriving lower bound or equality condition for s₁ from given constraints

| Constraints | Upper bound candidates |
|---|---|
| (37) | L = {1} |
| (38) | $If {s}_{2} \geq 0 , L = L ⋃ \{ 1 + \frac{2 {s}_{2}}{W} \}$ |
| | $If {s}_{2} < 0 , L = L ⋃ \{ 1 - \frac{2 {s}_{2}}{W} \}$ |
| (39) or (40) | If (\|s_{far} − dₘᵢₙ\| ≤ \|sₙₑₐᵣ − dₘₐₓ\|), |
| | $L = L ⋃ \{ \frac{{s}_{far} - 2 {s}_{2}}{{d}_{min}} \}$ |
| | If (\|s_{far} − dₘᵢₙ\| > \|sₙₑₐᵣ − dₘₐₓ\|), |
| | $L = L ⋃ \{ \frac{{s}_{n e a r} - 2 {s}_{2}}{{d}_{max}} \}$ |

Once the candidates are collected from the constraints, the closed form solution for s₁ can be obtained by

$${s}_{1}^{*} = max ( L ) \qquad ( 41 )$$

Note that the maximum among the lower bound or equality condition candidates to find one that meets all the imposed constraints can be taken, assuming that for certain s₂, the expression (41) gives the corresponding optimal s₁ that minimizes the optimization function in (36).

Then, the next step is to sweep through a range of values of s₂ to derive an optimal (s₁, s₂), where the range is set as

$$\vert {s}_{2} \vert \leq \frac{( {s}_{b o u n d} - 1 ) W}{2}$$

avoid the cases of up-sampling the views to a factor higher than s_{bound}. In case of s_{bound}=1.1 on FHD stereo video (W=1920), the s₂ sweep range becomes [−96, 96]. For each s₂, a corresponding s₁ that minimizes the cropped-out area can be derived using (41). Among them, a (s₁, s₂) pair is chosen with the smallest s₁ value since it minimizes the objective function of (36).

In another embodiment, the Scale/Shift Application module receives the scale/shift factors (s₁, s₂) determined from the scale/shift parameter decision process, left (It) and right views (Iᵣ) from the video decoder, and MODE_FLAG from the User Specified Input. Based on the received inputs the module outputs the scale/shift applied output video that are displayed on HMDs.

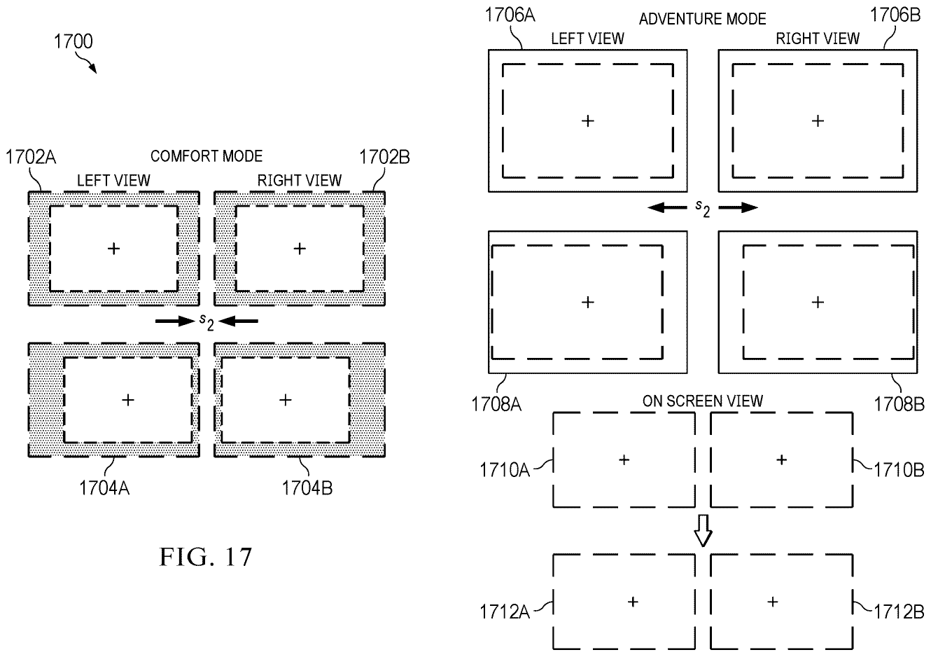

Before describing the flow diagram of the module, a high-level demonstration on how procedures for applying scale/shift can be different for Comfort and Adventure mode is provided. FIG. 17 shows an example of an effect of shift and/or scale for comfort and adventure modes that can be used with one or more embodiments of the invention.

The Comfort mode case, shown in 1702A-B, 1704A-B of FIG. 17, involves 0≤s₁≤1 which causes the views to be downscaled. Due to this, border area appears between the on-screen area, indicated as shaded, and the scaled down content area, indicated with a dotted line surrounding the “+”. This scaled down content area may take different part of the on-screen area depending on the given s₂. So, the overall procedures for generating output video for the Comfort mode will be to generate buffer planes that are initialized to zeros (black), then fill in the appropriate regions for each view based on the given (s₁, s₂).

The Adventure mode, shown in 1706A-B, 1708A-B of FIG. 17, involves 1≤s₁, which generates views that are larger than the on-screen area. In such case, the scaled-up views are cropped to the screen resolution. Again, depending on the s₂ given, the crop area may not be center aligned. So, the overall procedure here will be upscaling the views, and cropping them out on appropriate regions based on the given (s₁, s₂).

In one embodiment, attention is needed when processing s₂ on different modes. As discussed above, s₂ affects the coordinates of each view according to (17) and (18). In the case of Comfort mode, the direction to move the content area is consistent with the formerly defined coordinate shift direction. As shown from the arrows in FIG. 17, s₂>0 can be applied by shifting the content area of the left view to the right, and the right view to the left, thereby pulling the coordinates of both views toward each other.

However, in the case of Adventure mode, the content coordinate is not controlled but the offset directions for the on-screen area can be controlled. This on-screen area offset direction and the coordinate shift direction are in relative relation, where the direction becomes opposite to each other. As shown in FIG. 17, if want s₂>0 to have consistent effect of pulling the coordinates of both views closer towards each other, the on-screen area should be pushed further away from each other as shown in the arrows of Adventure mode of FIG. 17.

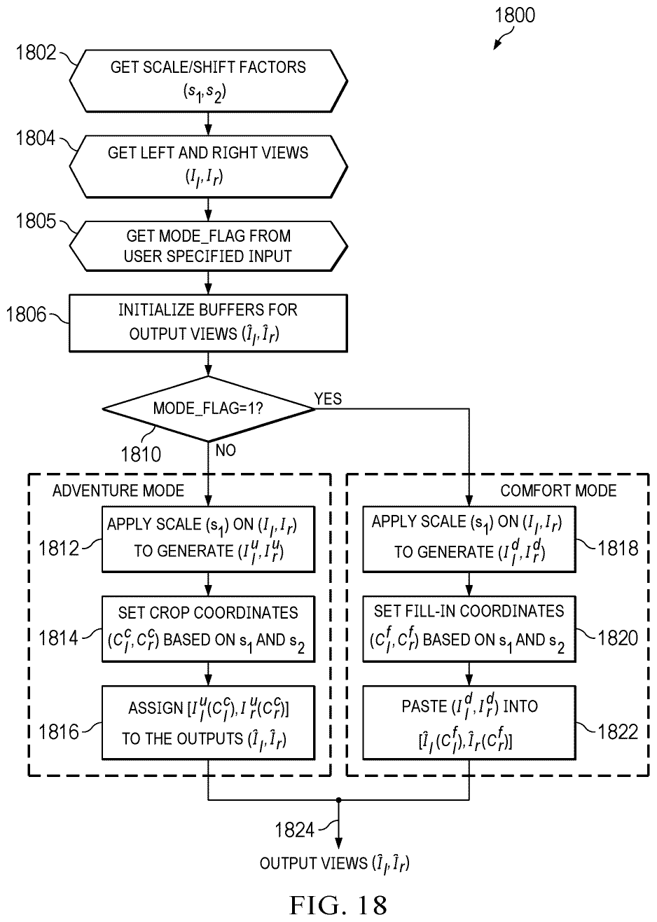

FIG. 18 shows, in a flow diagram, an example of a scale/shift application that can be used with one or more embodiments of the invention. In one embodiment, FIG. 18 illustrates the overall flow diagram of Scale/Shift Application process 1800. The process 1800 receives the inputs that are scale/shift factors (s₁, s₂) from the Scale/Shift Parameter decision module (1802), left (It) and right views (Iᵣ) from the video decoder (1804), and MODE_FLAG from the User Specified Input (1806). Here, it is assumed that Iₗ and Iᵣ are in three channel 4:4:4 RGB format on memory before showing on the display. As procedures for applying scale/shift factors on each channel will be identical, the left (Iₗ) and right views (Iᵣ) are continued to be denoted collectively as Iₗ and Iᵣ, instead of separating the variables for each channel.

Process 1800 further generates the buffer planes that are initialized to zero for the left and right output views denoted as Îₗ and Îᵣ, respectively (1808). Again, since these initial values of Ît and Îr and procedures to be applied to them on each channel are identical, they are denoted collectively instead of expressing them as separate variables.

At 1810, process 1800 determines the value of the mode flag. If the mode flag indicates the comfort mode from User Specified input, the process 1800 takes the operation branch for the Comfort mode (1818-1822).

At 1818, process 1800 applies s₁ on Iₗ and Iᵣ to generate

$${I}_{l}^{d} and {I}_{r}^{d} ,$$

respectively. Slice 0≤s₁≤1,

$${I}_{l}^{d} and {I}_{r}^{d}$$

have resolutions that are less than or equal to those of Iₗ and Iᵣ. In one embodiment, for generating these down sampled views, bicubic interpolation can be used. Alternatively, another kind of interpolation method can be used.

Process 1800 identifies (1820) which coordinate regions of the output buffer Îₗ and Îᵣ should be filled in with the generated

$${I}_{l}^{d} and {I}_{r}^{d} .$$

In this embodiment, Let

$${C}_{l}^{f} = ( {C}_{l , H}^{f} , {C}_{l , W}^{f} )$$

denote fill-in coordinates for the left view where

$${C}_{l , H}^{f} and {C}_{l , W}^{f}$$

each refer to vertical and horizontal fill-in coordinates, respectively. Then,

$${C}_{l , H}^{f} = [ {o}_{H} : H - {o}_{H} - 1 ] \qquad ( 42 )$$

$${C}_{l , W}^{f} = [ {o}_{W} + {s}_{2} : W - {o}_{W} + {s}_{2} - 1 ] \qquad ( 43 )$$

where H and W are height and width of Iₗ (or Iᵣ). The

$${o}_{W} = \frac{( 1 - {s}_{1} ) W}{2} and {o}_{H} = \frac{( 1 - {s}_{1} ) H}{2}$$

are horizontal and vertical offsets for aligning the centers of Iₗ (or Iᵣ) and

$${I}_{l}^{d} ( or {I}_{r}^{d} ) .$$

The fill-in coordinates for the right view can be derived similarly as follows. Let

$${C}_{r}^{f} = ( {C}_{r , H}^{f} , {C}_{r , W}^{f} )$$

denote fill-in coordinates for right view where

$${C}_{r , H}^{f} and {C}_{r , W}^{f}$$

each refer to vertical and horizontal fill-in coordinates, respectively. Then,

$${C}_{r , H}^{f} = [ {o}_{H} : H - {o}_{H} - 1 ] \qquad ( 44 )$$

$${C}_{r , W}^{f} = [ {o}_{W} - {s}_{2} : W - {o}_{W} - {s}_{2} - 1 ] \qquad ( 45 )$$

Note how the signs on the s₂ are applied oppositely for (42) and (43), similarly as in (18) and (18).

Process 1800 generates (1822) the output views by pasting the down scaled

$${I}_{l}^{d} and {I}_{r}^{d}$$

onto the Îₗ and Îᵣ on the areas specified by

$${C}_{l}^{f} and {C}_{r}^{f} .$$

Execution proceeds to 1824.

If the mode flag indication an adventure mode (e.g., mode flag=0), process 1800 executes 1812-1816. At 1812, process 1800 applies s₁ on Iₗ and Iᵣ to generate

$${I}_{l}^{u} and {I}_{r}^{u} ,$$

respectively. Since 1≤s₁, the

$${I}_{l}^{u} and {I}_{r}^{u}$$

have resolutions that are greater than or equal to those of Iₗ and Iᵣ. For generating these up sampled views, bicubic interpolation or another kind of interpolation method can be used.

Process 1800 identifies (1814) which coordinate regions of the upscaled

$${I}_{l}^{u} and {I}_{r}^{u}$$

should be cropped and saved to the output buffer Îₗ and Îᵣ. Let

$${C}_{l}^{c} = ( {C}_{l , H}^{c} , {C}_{l , W}^{c} )$$

denotes crop coordinates for the left view where

$${C}_{l , H}^{c} and {C}_{l , W}^{c}$$

each refer to vertical and horizontal crop coordinates, respectively. Then,

$${C}_{l , H}^{c} = [ {o}_{H} : {H}_{u} - {o}_{H} - 1 ] \qquad ( 46 )$$

$${C}_{l , W}^{c} = [ {o}_{W} - {s}_{2} : {W}_{u} - {o}_{W} - {s}_{2} - 1 ] \qquad ( 47 )$$

where Hᵤ and Wᵤ are height and width of

$${I}_{l}^{u} ( or {I}_{r}^{u} )$$

### The

$${o}_{W} = \frac{( {s}_{1} - 1 ) W}{2} and {o}_{H} = \frac{( {s}_{1} - 1 ) H}{2}$$

are horizontal and vertical offsets for aligning the centers of Iₗ (or Iᵣ) and

$${I}_{l}^{d} ( or {I}_{r}^{d} )$$

where H and W are height and width of Iₗ (or Iᵣ). Note how the sign of s₂ is applied oppositely when compared to the Comfort mode case in (43), which was explained above in FIG. 16.

The crop coordinates for the right view can be derived similarly as follows. Let

$${C}_{r}^{c} = ( {C}_{r , H}^{c} , {C}_{r , W}^{c} )$$

denote crop coordinates for right view where

$${C}_{r , H}^{c} and {C}_{r , W}^{c}$$

each refer to vertical and horizontal crop coordinates, respectively. Then,

$${C}_{r , H}^{c} = [ {o}_{H} : {H}_{u} - {o}_{H} - 1 ] \qquad ( 48 )$$

$${C}_{r , W}^{c} = [ {o}_{W} + {s}_{2} : {W}_{u} - {o}_{W} + {s}_{2} - 1 ] \qquad ( 49 )$$

Two things to note here are as follows. Firstly, signs on the s₂ are applied oppositely for (49) and (47) which are between the left and right views. Secondly, the sign of s₂ is applied oppositely when compared to the Comfort mode case in (45), explained above.

Process 1800 generates (1816) the output views by cropping the area specified by

$${C}_{l}^{c} and {C}_{r}^{c}$$

from

$${I}_{l}^{u} and {I}_{r}^{u}$$

and saving them to the output buffer Îₗ and Îᵣ. Execution proceeds to 1824. At 1824, process 1800 outputs the views (Îₗ, Îᵣ).

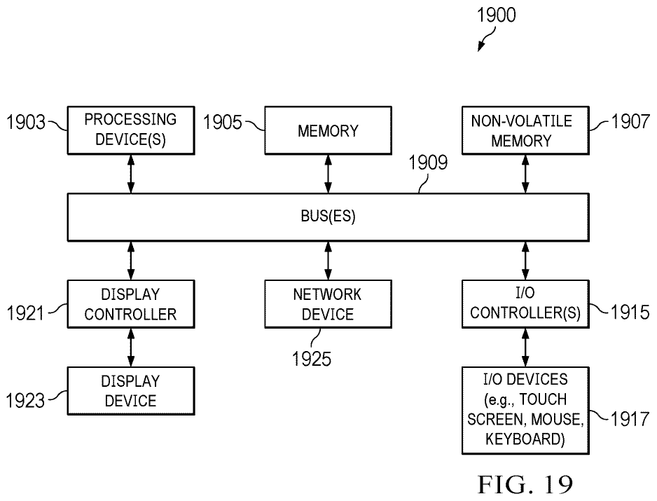

FIG. 19 shows an example of a data processing system 1900 that can be used by or in a camera or other device to provide one or more embodiments described herein. The systems and methods described herein can be implemented in a variety of different data processing systems and devices, including general-purpose computer systems, special purpose computer systems, or a hybrid of general purpose and special purpose computer systems. Data processing systems that can use any one of the methods described herein include a camera, a smartphone, a set top box, a computer, such as a laptop or tablet computer, embedded devices, game systems, and consumer electronic devices, etc., or other electronic devices.

FIG. 19 is a block diagram of data processing system 1900 hardware according to an embodiment. Note that while FIG. 19 illustrates the various components of a data processing system, it is not intended to represent any particular architecture or manner of interconnecting the components as such details are not germane to the present invention. It will also be appreciated that other types of data processing systems that have fewer components than shown or more components than shown in FIG. 19 can also be used with one or more embodiments of the present invention.

As shown in FIG. 19, the data processing system 1900 includes one or more buses 1909 that serve to interconnect the various components of the system. The system in FIG. 19 can include a camera or be coupled to a camera. One or more processing devices 1903 are coupled to the one or more buses 1909 as is known in the art. Memory 1905 may be DRAM or non-volatile RAM or may be flash memory or other types of memory or a combination of such memory devices. This memory is coupled to the one or more buses 1909 using techniques known in the art. The data processing system can also include non-volatile memory 1907, which may be a hard disk drive or a flash memory or a magnetic optical drive or magnetic memory or an optical drive or other types of memory systems that maintain data even after power is removed from the system. The non-volatile memory 1907 and the memory 1905 are both coupled to the one or more buses 1909 using known interfaces and connection techniques. A display controller 1921 is coupled to the one or more buses 1909 in order to receive display data to be displayed on a display device which can be one of displays. The data processing system 1900 can also include one or more input/output (I/O) controllers 1915 which provide interfaces for one or more I/O devices, such as one or more cameras, touch screens, ambient light sensors, and other input devices including those known in the art and output devices (e.g., speakers). The input/output devices 1917 are coupled through one or more I/O controllers 1915 as is known in the art. The ambient light sensors can be integrated into the system in FIG. 19.

While FIG. 19 shows that the non-volatile memory 1907 and the memory 1905 are coupled to the one or more buses directly rather than through a network interface, it will be appreciated that the present invention can utilize non-volatile memory that is remote from the system, such as a network storage device which is coupled to the data processing system through a network interface such as a modem or Ethernet interface. The buses 1909 can be connected to each other through various bridges, controllers and/or adapters as is well known in the art. In one embodiment the I/O controller 1915 includes one or more of a USB (Universal Serial Bus) adapter for controlling USB peripherals, an IEEE 1394 controller for IEEE 1394 compliant peripherals, or a Thunderbolt controller for controlling Thunderbolt peripherals. In one embodiment, one or more network device(s) 1925 can be coupled to the bus(es) 1909. The network device(s) 1925 can be wired network devices (e.g., Ethernet) or wireless network devices (e.g., Wi-Fi, Bluetooth) that receive images from a camera, etc.

Although separate embodiments are enumerated below, it will be appreciated that these embodiments can be combined or modified, in whole or in part, into various different combinations. The combinations of these embodiments can be any one of all possible combinations of the separate embodiments.

Embodiment 1 is a method comprising:
computing, with a decoding device, a comfort threshold using a parameter input by a user. receiving a stereo video stream and metadata corresponding to the stereo video stream, wherein the metadata includes an indication of disparities between a corresponding left and right frame of the stereo video stream;
computing a post-processing factor for the stereo video stream using the metadata and comfort threshold; and
processing the stereo video stream using the post-processing factor.

Embodiment 2 is a method of embodiment 1 wherein the inputted parameter is one or more of interpupillary distance (IPD) screen distance, screen size, and pixels/screen.

Embodiment 3 is a method of embodiment 2, wherein the computing of the comfort threshold comprises:
computing the comfort threshold using the IPD, screen distance, screen size, and pixels/screen.

Embodiment 4 is a method of embodiment 1, wherein the post-processing factor is one or more of a scale factor and a shift factor.

Embodiment 5 is a method of embodiment 4, wherein the processing the stereo video stream comprises:
scaling the stereo video stream using the scaling factor.

Embodiment 6 is a method of embodiment 4, wherein the processing the stereo video stream comprises:
shifting each pair of frames in the stereo video stream using the shifting factor, wherein a shifting includes shifting a left side frame towards a corresponding right side frame or shifting the left side frame away from the corresponding right side frame.

Embodiment 7 is a method of embodiment 1, wherein the computing of the post-processing factor includes:
retrieving disparity statistics from the metadata, wherein the disparity statistics include the indications of disparities between corresponding left and right frames of the stereo video stream;
   retrieving comfort threshold; and

computing the post-processing factor using the disparity statistics and comfort threshold.

Embodiment 8 is a method of embodiment 7, wherein the disparity statistics are the range of disparities that a frame of the video stream covers.

Embodiment 9 is a method of embodiment 7, wherein the disparity statistics are computed by an encoding device that encoded the stereo video stream.

Embodiment 10 is a method of embodiment 7, wherein the disparity statistics includes (dₘᵢₙ, dₘₐₓ) values for each frame.

Embodiment 11 is a method of embodiment 7, wherein the input mode is one of a comfort mode and an adventure mode, the comfort mode reduces a sense of depth and is used when stereo video stream includes a disparity that is outside a comfort zone range, and the adventure mode increases the sense of depth and is used when the disparity is within the comfort zone range.

Embodiment 12 is a method of embodiment 1, wherein the computing of the post-processing factor uses at least one of an input mode and a threshold control.

Embodiment 13 is a method of embodiment 1, wherein the processing further comprises minimizing a border around at least one of video stream of the stereo video stream.

Embodiment 14 is a method of embodiment 13, wherein the minimizing further comprises creating a set of possible scale and shift factor pairs, wherein each of the possible scale and shift factor pairs is associated with a border area value and determining a final scale and shift factor pair from the set of possible scale and shift factor pairs that minimizes the border area value.

Embodiment 15 is a method of embodiment 13, wherein the minimizing comprises determining a set of scale factor upper bound candidates, selecting a minimum scale factor from the set of scale factor upper bound candidates that, performing a sweep of shift factors using the selected scale factor to determine a final shift factor, and returning the selected scale factor and final shift factor.

Embodiment 16 is a method of embodiment 1, wherein the processing further comprises determining that a mode is a comfort mode, applying a scale factor to a left and right view of the stereo video stream to generate scaled left and right views, wherein the resolutions of the scaled views are equal to or less than the resolution of the un-scaled views, setting a set of fill-in coordinates using a scale and the shift factor, and pasting the scaled views into the un-scaled views in an area associated with the set of fill-in coordinates.

Embodiment 16 is a method of embodiment 1, wherein the processing further comprises determining that a mode is an adventure mode, applying a scale factor to a left and right view of the stereo video stream to generate scaled left and right views, wherein the resolutions of the scaled views are greater than or equal to the resolution of the un-scaled views, setting a set of crop coordinates using a scale and the shift factor; and cropping an area associated with the set of crop coordinates of the scaled views into the un-scaled views.

Embodiment 17 is a method of embodiment 1, wherein the processing further comprises determining that a mode is an adventure mode, applying a scale factor to a left and right view of the stereo video stream to generate scaled left and right views, wherein the resolutions of the scaled views are greater than or equal to the resolution of the un-scaled views setting a set of crop coordinates using a scale and the shift factor, and cropping an area associated with the set of crop coordinates of the scaled views into the un-scaled views.

Embodiment 18 is a method of embodiment 1, wherein the processing further comprises minimizing a crop-out area for at least one of video stream of the stereo video stream.

Embodiment 19 is a method of embodiment 18, wherein the minimizing further comprises creating a set of possible scale and shift factor pairs, wherein each of the possible scale and shift factor pairs is associated with a crop-out area value and determining a final scale and shift factor pair from the set of possible scale and shift factor pairs that minimizes the cop-out area value.

Embodiment 20 is a method of embodiment 18, wherein the minimizing factor comprises determining a set of scale factor lower bound candidates, selecting a scale factor from the set of scale factor lower bound candidates that is a maximum, performing a sweep of shift factors using the selected scale factor to determine a final shift factor, and returning the selected scale factor and final shift factor.

Embodiment 21 is an apparatus comprising a processing system and memory and configured to perform any one of the methods in claims 1-19.

Embodiment 22 is a non-transitory machine-readable storage storing executable program instructions which when executed by a machine cause the machine to perform any one of the methods of claims 1-19.

It will be apparent from this description that one or more embodiments of the present invention may be embodied, at least in part, in software. That is, the techniques may be carried out in a data processing system in response to its one or more processors executing a sequence of instructions contained in a storage medium, such as a non-transitory machine-readable storage medium (e.g., DRAM or flash memory). In various embodiments, hardwired circuitry may be used in combination with software instructions to implement the present invention. Thus, the techniques are not limited to any specific combination of hardware circuitry and software, or to any particular source for the instructions executed by the data processing system.

In the foregoing specification, specific exemplary embodiments have been described. It will be evident that various modifications may be made to those embodiments without departing from the broader spirit and scope set forth in the following claims. The specification and drawings are, accordingly, to be regarded in an illustrative sense rather than a restrictive sense.

Various aspects of the present invention may be appreciated from the following Enumerated Example Embodiments (EEEs):

EEE 1. A method comprising:
computing, with a decoding device, a comfort threshold using a parameter input by a user;
receiving a stereo video stream and metadata corresponding to the stereo video stream, wherein the metadata includes an indication of disparities between a corresponding left and right frame of the stereo video stream;
computing a post-processing factor for the stereo video stream using the metadata and comfort threshold; and
processing the stereo video stream using the post-processing factor.

EEE 2. The method of EEE 1 wherein the inputted parameter includes one or more of interpupillary distance (IPD) screen distance, screen size, and pixels/screen.

EEE 3. The method of EEE 2, wherein the computing of the comfort threshold comprises:
computing the comfort threshold using the IPD, screen distance, screen size, and pixels/screen.

EEE 4. The method of any one of EEEs 1 to 3, wherein the post-processing factor is one or more of a scale factor and a shift factor.

EEE 5. The method of EEE 4, wherein the processing the stereo video stream comprises:
scaling the stereo video stream using the scaling factor.

EEE 6. The method of EEE 4, wherein the processing the stereo video stream comprises:
shifting each pair of frames in the stereo video stream using the shifting factor, wherein a shifting includes shifting a left side frame towards a corresponding right side frame or shifting the left side frame away from the corresponding right side frame.

EEE 7. The method of any one of EEEs 1 to 6, wherein the computing of the post-processing factor includes:
retrieving disparity statistics from the metadata, wherein the disparity statistics include the indications of disparities between corresponding left and right frames of the stereo video stream;
retrieving comfort threshold; and
computing the post-processing factor using the disparity statistics and comfort threshold.

EEE 8. The method of EEE 7, wherein the disparity statistics are the range of disparities that a frame of the video stream covers.

EEE 9. The method of EEE 7 or 8, wherein the disparity statistics are computed by an encoding device that encoded the stereo video stream.

EEE 10. The method of any one of EEEs 7 to 9, wherein the disparity statistics includes (dₘᵢₙ, dₘₐₓ) values for each frame.

EEE 11. The method of any one of EEEs 7 to 10, wherein the input mode is one of a comfort mode and an adventure mode, the comfort mode reduces a sense of depth and is used when stereo video stream includes a disparity that is outside a comfort zone range, and the adventure mode increases the sense of depth and is used when the disparity is within the comfort zone range.

EEE 12. The method of any one of EEEs 1 to 11, wherein the computing of the post-processing factor uses at least one of an input mode and a threshold control.

EEE 13. The method of any one of EEEs 1 to 12, wherein the processing further comprises:
minimizing a border around at least one of video stream of the stereo video stream.

EEE 14. The method of EEE 13, wherein the minimizing further comprises:
creating a set of possible scale and shift factor pairs, wherein each of the possible scale and shift factor pairs is associated with a border area value; and
determining a final scale and shift factor pair from the set of possible scale and shift factor pairs that minimizes the border area value.

EEE 15. The method of EEE 13 or 14, wherein the minimizing further comprises:
determining a set of scale factor upper bound candidates;
selecting a scale factor from the set of scale factor upper bound candidates that is minimum;
performing a sweep of shift factors using the selected scale factor to determine a final shift factor; and.
returning the selected scale factor and final shift factor.

EEE 16. The method of any one of EEEs 1 to 15, wherein the processing further comprises:
determining that a mode is a comfort mode;
applying a scale factor to a left and right view of the stereo video stream to generate scaled left and right views, wherein the resolutions of the scaled views are equal to or less than the resolution of the un-scaled views;
setting a set of fill-in coordinates using a scale and the shift factor; and
pasting the scaled views into the un-scaled views in an area associated with the set of fill-in coordinates.

EEE 17. The method of any one of EEEs 1 to 16, wherein the processing further comprises:
determining that a mode is an adventure mode;
applying a scale factor to a left and right view of the stereo video stream to generate scaled left and right views, wherein the resolutions of the scaled views are greater than or equal to the resolution of the un-scaled views;
setting a set of crop coordinates using a scale and the shift factor; and
cropping an area associated with the set of crop coordinates of the scaled views into the un-scaled views.

EEE 18. The method of any one of EEEs 1 to 17, wherein the processing further comprises:
minimizing a crop-out area for at least one of video stream of the stereo video stream.

EEE 19. The method of EEE 18, wherein the minimizing further comprises:
creating a set of possible scale and shift factor pairs, wherein each of the possible scale and shift factor pairs is associated with a border area value; and
determining a final scale and shift factor pair from the set of possible scale and shift factor pairs that maximizes the border area value.

EEE 20. The method of EEE 18 or 19, wherein the minimizing further comprises: determining a set of scale factor lower bound candidates;
selecting a scale factor from the set of scale factor lower bound candidates that is a maximum;
performing a sweep of shift factors using the selected scale factor to determine a final shift factor; and.
returning the selected scale factor and final shift factor.

EEE 21. An apparatus comprising a processing system and memory and configured to perform any one of the methods in EEEs 1-20.

EEE 22. A non-transitory machine-readable storage storing executable program instructions which when executed by a machine cause the machine to perform any one of the methods of EEEs 1-20.

1. A method comprising:
receiving a user input comprising at least one viewing condition parameter, and a stereo video stream and metadata corresponding to the stereo video stream, wherein the metadata includes an indication of disparities between a corresponding left view and right view of the stereo video stream;
determining, with a decoding device, a comfort threshold based on the viewing condition parameter, the comfort threshold indicating a range of disparities that fall within a zone of comfort;
computing a post-processing factor based on the metadata and comfort threshold, the post-processing factor comprising one or more of a scale factor and a shift factor; and
applying the post-processing factor to the stereo video stream by:
scaling a corresponding left and right view of the stereo video stream using the scale factor, and/or
shifting the corresponding left and right view of the stereo video stream using the shifting factor, wherein a shifting includes shifting a left view towards a corresponding right view or shifting the left view away from the corresponding right view.

2. The method of claim 1, wherein the viewing condition parameter includes one or more of interpupillary distance (IPD) screen distance, screen size, and pixels/screen.

3. The method of claim 2, wherein the computing of the comfort threshold comprises:
computing the comfort threshold using the IPD, screen distance, screen size, and pixels/screen.

4. The method of claim 1, wherein the computing of the post-processing factor includes:
retrieving disparity statistics from the metadata, wherein the disparity statistics include the indications of disparities between corresponding left and right views of the stereo video stream;
retrieving the comfort threshold; and
computing the post-processing factor based on the disparity statistics and comfort threshold.

5. The method of claim 4, wherein the disparity statistics are the range of disparities that a frame of the video stream covers.

6. The method of claim 4, wherein the disparity statistics are computed by an encoding device that encoded the stereo video stream.

7. The method of claim 4, wherein the disparity statistics includes (dₘᵢₙ, dₘₐₓ) values, wherein dₘᵢₙ indicates a minimum disparity value between the left and right view and dₘₐₓ indicates a maximum disparity value between the left and right view.

8. The method of claim 4, comprising:
receiving an input mode, wherein the input mode is one of a comfort mode and an adventure mode,
wherein, when the comfort mode is selected, the post-processing factor is such that applying the post-processing factor reduces a sense of depth, and, when the adventure mode is selected, the post-processing factor is such that applying the post-processing factor increases the sense of depth.

9. The method of claim 1, wherein the computing of the post-processing factor uses at least one of an input mode and a threshold control.

10. The method of claim 1, wherein computing the post-processing factor further comprises:
determining a value of the scale factor and/or shift factor such that a border around each of the left and right view resulting from the scaling and/or shifting of the view is minimized.

11. The method of claim 10, wherein the minimizing comprises creating a set of possible scale and shift factor pairs, wherein each of the possible scale and shift factor pairs is associated with a border area value and determining a final scale and shift factor pair from the set of possible scale and shift factor pairs that minimizes the border area value.

12. The method of claim 10, wherein the minimizing comprises determining a set of scale factor upper bound candidates, selecting the minimum scale factor from the set of scale factor upper bound candidates, performing a sweep of shift factors using the selected scale factor to determine a final shift factor, and returning the selected scale factor and final shift factor.

13. The method of claim 1, wherein computing the post-processing factor further comprises:
determining a value of the scale factor and/or shift factor such that a crop-out area for each of the left and the right view resulting from the scaling and/or shifting of the view is minimized.

14. The method of claim 13, wherein the minimizing comprises creating a set of possible scale and shift factor pairs, wherein each of the possible scale and shift factor pairs is associated with a crop-out area value and determining a final scale and shift factor pair from the set of possible scale and shift factor pairs that minimizes the crop-out area value.

15. The method of claim 13, wherein the minimizing comprises determining a set of scale factor lower bound candidates, selecting a maximum scale factor from the set of scale factor lower bound candidates, performing a sweep of shift factors using the selected scale factor to determine a final shift factor, and returning the selected scale factor and final shift factor.

16. The method of claim 8, wherein the post-processing factor comprises both a scale factor and a shift factor and wherein the input mode is a comfort mode;
wherein the step of applying the post-processing factor comprises downscaling the left and right view of the stereo video stream to generate scaled left and right views, wherein the resolutions of the scaled views are equal to or less than the resolution of the un-scaled views;
the method further comprising, for each of the left view and the right view:
generating a buffer plane, the buffer plane being initialized to black;
determining a set of fill-in coordinates based on the scale factor and the shift factor; and
filling the region of the buffer corresponding to the fill-in coordinates with the respective scaled view.

17. The method of claim 8, wherein the post-processing factor comprises both a scale factor and a shift factor, and wherein the input mode is an adventure mode;
wherein the step of applying the post-processing factor comprises upscaling the left and right view of the stereo video stream to generate scaled left and right views, wherein the resolutions of the scaled views are greater than or equal to the resolution of the un-scaled views;
generating a buffer plane, the buffer plane being initialized to black;
determining a set of crop coordinates using the scale factor and the shift factor; and
saving an area associated with the set of crop coordinates of the scaled views to the buffer.

18. An apparatus comprising a processing system and memory and configured to perform the method in claim 1.

19. A non-transitory machine-readable storage storing executable program instructions which when executed by a machine cause the machine to perform any one of the method of claim 1.
